(19) United States
(12) Patent Application Publication
(10) Pub. No.: US 2025/0029269 A1
(43) Pub. Date: Jan. 23, 2025

(54) METHOD AND SYSTEM FOR BUILDING INFORMATION MODELING (BIM) RECONSTRUCTION FOR A PIPING SYSTEM

(71) Applicants: NANYANG TECHNOLOGICAL UNIVERSITY, Singapore (SG); SURBANA JURONG PTE LTD, Singapore (SG)

(72) Inventors: Yuan XIE, Singapore (SG); Yiyu CAI, Singapore (SG)

(73) Assignees: NANYANG TECHNOLOGICAL UNIVERSITY, Singapore (SG); SURBANA JURONG PTE LTD, Singapore (SG)

(21) Appl. No.: 18/713,566

(22) PCT Filed: Nov. 21, 2022
(86) PCT No.: PCT/SG2022/050848

§ 371 Date: May 24, 2024

(30) Foreign Application Priority Data
Nov. 26, 2021 (SG) 10202113171Y

(51) Int. Cl. G06T 7/62; G06T 17/00; G06V 10/44; G06V 10/764; G06V 10/766; G06V 10/86

(52) U.S. Cl. CPC G06T 7/62; G06T 17/00; G06V 10/457; G06V 10/764; G06V 10/766; G06V 10/86; G06T 2207/10028; G06T 2210/04; G06T 2210/56

(57) ABSTRACT

A method of BIM reconstruction for a piping system is provided. The method includes: obtaining a point cloud patch with respect to a seed point for the point cloud patch from point cloud data obtained with respect to the piping system, the point cloud patch including the seed point and a first plurality of neighbor points with respect to the seed point; embedding, for each of the first plurality of neighbor points, neighborhood features with respect to the neighbor point to the neighbor point to form a neighborhood feature embedded point cloud patch; generating a point cloud sub-patch including a second plurality of neighbor points from the first plurality of neighbor points of the neighborhood feature embedded point cloud patch, each of the second plurality of neighbor points being determined to belong to a same pipe segment as the seed point using a first machine learning model; determining whether the seed point is a pipe point based on the point cloud sub-patch using a second machine learning model; and determining a pipe centerline point associated with the seed point based on the point cloud sub-patch and based on determining that the seed point is a pipe point. There is also provided a corresponding system for BIM reconstruction for a piping system.

### CROSS-REFERENCE TO RELATED APPLICATION

This application claims the benefit of priority of Singapore Patent Application No. 10202113171Y, filed on 26 Nov. 2021, the content of which being hereby incorporated by reference in its entirety for all purposes.

### TECHNICAL FIELD

The present invention generally relates to a method of building information modeling (BIM) reconstruction for a piping system, and a system thereof.

### BACKGROUND

Documentation for buildings and facilities was a tedious and laborious task in the past when all the components are represented in 2D schematic drawings. With the development of the computer-aided design (CAD) technology, documentation becomes faster, and document revision and updates are easy to track and share among designers, constructors, and other stakeholders. CAD further lays the foundation of BIM, which stores not only geometries but also other metadata or attributes for example material and energy specifications, manufacturer, and cost, etc. The metadata can provide the necessary information throughout different phases of the facility life cycle from planning and construction, operation and maintenance (O&M) to demolition. Leveraging parametric design characteristics, changes to component instances can be updated easily in BIM. Thus, as an integrated information platform, BIM bridges the communication, collaboration, and interoperability gaps among stakeholders across disciplines.

Among all phases of the building life cycle, O&M lasts the longest and has been found to be the largest source of cost waste. Mechanical, electrical, and plumbing (MEP), as a critical and complicated system providing necessary services in all buildings, usually requires the most regular maintenance. It has been reported that the costs of MEP system maintenance can take up to 50% of the total investment in large-sized public projects. Poor maintenance of aging MEP systems can cause significant impacts operationally, economically, and even environmentally. Applying BIM to MEP management has drawn more and more attention in construction inspection and O&M. BIM-aided MEP O&M can effectively control maintenance cost wastes. The integrated information platform increases efficiency of data-querying and data-exchange. The 3D geometry and the structured metadata provides in-time accurate visualization and assists the manager with comprehensive decision-making. The digital twin allows virtual simulation and monitoring for operation optimization. These advantages can be further amplified with the integration of Internet of Things (IoT) and machine learning methods to achieve strategized maintenance framework such as predictive maintenance in which the necessary maintenance is provided to minimize facility downtime and extend facility operation lifespan.

An adequately updated BIM model is required in order to leverage BIM on MEP system O&M. While BIM has been gradually advocated and implemented for new buildings and facilities, the BIM model designed by architects and engineers, or the as-designed BIM model, usually contain deviations from the actual built environment due to construction errors or accommodation to site conditions. Conventionally, during the project handover, typically the owner will send inspectors to verify the constructed facility against the as-designed BIM model and request the constructor to correct the errors if needed and update the as-designed BIM model according to the built condition. The updated BIM model is thus called the as-built BIM which reflects the actual built environment. The as-built verification process is mostly carried out manually in the current industry practice which is time-consuming and inefficient. The surveyors head down to the site and scan it using terrestrial laser scanners typically, which are also called Light Detection and Ranging (LiDAR). Point cloud data is generated, comprising a large number (e.g., millions) of points each encoded with the relative location from the contact point of the laser and the object surface to the scanner and sometimes the surface color or the laser reflection intensity. The modelers would then import the point cloud to BIM authoring software such as REVIT, superimpose the point cloud on the as-designed BIM model, and revise the model accordingly. This process applies the same to existing buildings with outdated as-built BIM models because of maintenance and retrofit works carried out. As for old buildings without BIM documentation, the modelers would have to create the entire BIM model from scratch, with reference to the point cloud. Accordingly, conventionally, the so-called scan-to-BIM process typically can take up to months depending on the estate scale and complexity, in which the modeling time can takes 90%. The MEP system, compared to structural and architectural components such as slabs, walls and doors, can be more complicated and error-prone in the manual modeling process due to its small sizes, variety of dimensions, relatively free-formed shapes, and concealed or self-occluded arrangements.

A lot of research has been done to facilitate the MEP scan-to-BIM process. Most of the works focused on the cylindrical pipes which are the most frequent elements in the MEP system and formulated the problem as cylinder extraction. They heavily relied on handcrafted geometric features such as point normal or curvature to classify the cylinder points and calculate the cylinder parameters. Those features are not available in the raw data but are obtained by additional preprocessing steps which not only cost computation time but also can introduce errors, especially with noisy data. Furthermore, computation of those features usually requires a non-trivial step of parameter setting. In environments with complex MEP systems, the setting of the parameters may not be straightforward and subsequent parameter tuning needs to be performed. Some works also made assumptions on the pipe directions and dimensions which limit the generalization of the methods. Besides, few works attempt to maximize the connectivity completeness of the resulted piping systems and thus do not address various associated problems such as incomplete scans and heavy occlusion which may be common in the point clouds. Several software packages are commercially available to assist the modeling process by extracting some primitive shapes such as planes and cylinders from the point cloud. However, a large amount of manual work is still required such as setting parameters, building the object connectivity relations, and assigning metadata to make it a complete BIM model, and the manual work is deemed to be the bottleneck of the whole modeling process. Furthermore, the software or tools usually have specific requirements for the point cloud data such as structured point cloud or proprietary formats.

### Pipe Reconstruction

### Point Cloud Feature Extraction

Normal vector is the most-used feature in 3D geometry processing. For example, fit a flat plane or higher-order surface to calculate the surface normal, or perform Principal Component Analysis (PCA) to assign the eigenvector corresponding to the smallest eigenvalue as the normal. These methods often face the problem of neighborhood size selection. Especially when the input point cloud is noisy, cluttered, or incomplete, setting this size parameter is non-trivial: too large neighborhood leading to unreliable local geometric properties and too small leading to be overwhelmed by noises. Selection of the neighborhood size is typically done experimentally. Some methods are proposed to identify the optimal results by exploring properties of multi-scale neighborhood sizes. For example, there has been disclosed a method for improving the normal estimation by examining multiple neighborhoods with a preset list of neighborhood sizes. In each neighborhood, a surface roughness value was computed as the average deviation distance to the best-fitted circle. The neighborhood scale with the smallest surface roughness was used to derive the final normal. There has also been a method which searched top-down from an octree of the point cloud and applied RANSAC plane fitting to divide the scene into the largest possible consistent planar neighborhoods. Then all points in the same neighborhood inherited the plane normal as their normal. Previous works have also presented a deterministic MM-estimator approach to selecting neighbor points followed by PCA to estimate the normal.

There has been disclosed methods which apply deep learning to point cloud parsing. For example, methods of pure deep learning and methods combining deep learning and geometric feature descriptors or prior knowledge were proposed for point normal estimation. There has also been disclosed the combination of PCA and Convolutional neural network (CNN) to estimate the point normal. The query point together with its neighbors were projected to the plane defined by the normal calculated by PCA to generate a height map. All height maps were learned through a CNN to classify the query points as an edge or non-edge points, followed by another two CNNs to predict normals for the edge and non-edge points respectively. There has also been disclosed the use of a graph neural network to iteratively refine the weights of neighbor points followed by a weighted least-square plane fitting. In general, deep-learning-based methods outperform the traditional methods and can be more robust to noises. Nevertheless, the root mean square (RMS) angular error can vary between 6-23 degrees with noise levels smaller than 10% of the object bounding box size.

Curvature is another commonly used geometric feature. Ideally, a point on a cylindrical surface has its maximum principal curvature value equal to the reciprocal of the cylinder radius with direction along the surface normal and the minimum curvature value equal to zero and direction along the cylinder centerline axis. Different surface fitting methods were used to estimate the point curvature such as NURBS (non-uniform rational basis spline) and quadratic surface. There has also been disclosed a method for reducing of the 3D curvature estimation problem to iterative circle fitting on projection planes containing both the query point and the point normal. The circles with the maximum and the minimum radii were selected to determine the final principal curvatures.

### Pipe Detection

Object detection from point clouds involves extraction of the points corresponding to the target objects and object classification. For pipes, the problem may be formulated as cylinder primitive detection. The common instance segmentation method is region growing which clusters points in proximity to the seed points with similar point features, for example point normal and uniformity to the best-fit circle. For example, there has been disclosed a method which extracted the pipe segments by finding point clusters that were connected in both the projection planes and the k-nearest neighbors (k-NN) graph in 3D space, and then classified the clusters by circle detection in the refined projection planes. There has also been disclosed a method which detected the common directions of pipes in the scene using a Gaussian sphere and extracted the pipe instances by detecting circles in the projection planes. The clusters are examined again to exclude non-cylinder objects, for example, circle detection in the projection along the principal direction, RANdom SAmple Consensus (RANSAC) cylinder fitting, eigenvector-based projection analysis, curvature analysis, or checking curvature and therefore cylinder radius against existing component catalog P&ID (piping and instrumentation diagram). Some other works used existing CAD or BIM models for the target object extraction.

Research works have proposed to apply deep learning neural networks to point cloud segmentation. For example, there has been proposed a deep learning and convex optimization combined method to segment random objects into flat faces. The objective of such works is to segment the point cloud into different structural and architectural objects, for example walls, slabs, and furniture through training on similar datasets. However, due to the lack of MEP components in the available open-source datasets, there is little literature on applying deep learning methods to MEP-related object detection. For example, there has been disclosed a method which created an industrial MEP facility dataset and trained a customized PointNet++ for MEP object segmentation. However, that dataset was not made publicly accessible. There has also been disclosed a method which trained PointNet on synthesized point clouds from as-designed BIM models to do point cloud semantic classification and then further segmented points of each class into object instances using Euclidean clustering. There has further been disclosed a method which constructed a DeepPipe neural network with backbone of PointCNN and trained it on a synthesized dataset to semantically classify the MEP objects in the point cloud and for each pipe point predict its radius and the offset vector from the point to the centerline. The radius prediction is formatted as a classification task using a predefined discrete list. There has also been disclosed a method which developed a semantic classification network consisting of a CNN followed by a recurrent neural network (RNN) and trained it on privately scanned and manually labeled data. However, all of these works applied the deep learning networks directly to the point clouds of the entire scene. Due to the limited memory capacity of the conventional computational power, in most cases the raw point clouds cannot be loaded onto the devices directly and have to be pre-processed first. In this regard, there have been disclosed methods for dividing the point clouds into smaller portions, e.g., 1 m by 1 m blocks with equal number of points sampled in each block and directly down-sampling the point clouds with a grid (voxel) size of 3 cm or 4 cm. Therefore, these methods are essentially not applicable to relatively large scenes with small pipes (e.g., with diameter less than 5 cm) as those small pipes tend to be filtered in the down-sampling process. Besides the above mentioned methods that apply deep learning networks on point clouds, there has also been disclosed a method which detected MEP components from 2D images using a CNN network, DeepLabv3+, trained on manually labeled 2D MEP images. The classification results were then transferred to the point cloud, and DBSCAN was applied to further segment the points of each class into instances.

### Pipe Modeling

Common methods used in pipe modeling are RANSAC and Hough transform (HT). For example, there has been proposed a RANSAC cylinder fitting method using two random data points together with their normal vectors. The direction of the cylinder centerline was determined by the cross product of the normal vectors and the radius was the distance from one of the data points to the centerline. However, in practice, many false positives could be generated if applying RANSAC method directly to a point cloud of a large-scale scene with pipes. Several thresholds can be set to prune the false positives, for example, the number of inlier points, length, radius, and the angular point coverage. Apart from RANSAC cylinder fitting, methods combining RANSAC plane or circle fitting and Gaussian sphere have also been proposed. This is because of the property that the Gaussian sphere with normal vectors of points from a cylinder will display a 2D circular pattern. The RANSAC plane fitting is usually applied on the Gaussian sphere to detect the cylinder centerline directions and the RANSAC circle fitting is used to estimate the cylinder radius. For example, there has been disclosed a method which formulated the 3D cylinder detection problem into 2D circle detection with the assumption that the cylinder directions were either perpendicular or parallel to the ground plane.

HT method detects primitive shapes by parameter voting mechanism. The large memory space required by the 5-dimensional Hough accumulator makes it prohibitive to apply HT directly for 3D cylinder detection, particularly with input data that can comprise a few million points. For example, there has been proposed a 2-step sequential HT to reduce the Hough space dimensionality. The cylinder centerline direction is estimated first using a 3D Hough Gaussian sphere, and then the radius and position estimation is formulated as an HT circle detection problem on the projection plane. Manhattan-world assumption has been applied in some works, i.e., the pipes are assumed to be installed along the three orthogonal directions of the scene. For example, there has been disclosed a method which leveraged the Manhattan-world assumption and applied 2D HT circle detection on the projections of orthogonal slices at predefined distance intervals. In practice, the Hough accumulator needs to be discretized into a certain granularity, which results in the dilemma that a higher granularity gives more accurate estimation with the sacrifice of computational time; while a lower granularity boosts the computing speed and requires less memory space, but the result accuracy is jeopardized. In an attempt to solve this problem, a few modifications to the sequential HT have been proposed, for example iteratively increasing the granularity at the regions of interests in the Hough space, or sampling denser cells in favor of the orientations that the cylinders may lie along according to the user's prior knowledge of the input scene.

There is another category of skeleton-based methods, which followed the principle that pipes, including the straight cylindrical segments and the connectors such as elbows and tees, can be represented in an abstract skeleton form defined by the centerlines and the radii. The skeleton nodes were proposed to be estimated by curvature computation, Voronoi diagram-based method, and RANSAC sphere fitting. The Voronoi diagram method implicitly required a relatively large angular scan coverage of the pipes, and the RANSAC sphere fitting method required prior knowledge of the cylinder diameter range to adjust the neighborhood size for candidate generation. A large neighborhood would increase the computation time while a small neighborhood could not detect pipes with large radii because they would be potentially miss classified as planes. For example, there has been disclosed a method which estimated the centerline nodes by applying circle fitting on the cross-sectional slices at predefined interval steps along the orthogonal axes and other known directions and then clustered the centerline nodes using DBSCAN.

Other statistical analysis methods have also been proposed for cylinder modeling, for example, PCA for centerline direction estimation and circle fitting in the 2D projections. PCA direction estimation can be inaccurate with short pipe segments. It is also observed on real scanned data that circle fitting on 2D projections can be inaccurate for long and small pipes because they may not necessarily exist in a perfectly straight manner due to gravity or installation error. There has been proposed a method to fit ellipses on the intersections of random slicing planes and the point cloud and generate cylinder candidates based on the geometric relationship between the ellipse and the cylinder. The cylinder candidates were then clustered by maximizing all the candidates' pairwise similarities determined by the distances between cylinders. However, generating the random slicing planes itself can be non-trivial for a non-oriented point cloud of a large scene with complex piping systems.

Some works reconstructed the pipe connectivity relationships after the pipe modeling step. Most of them simply connected pipes that have line distances or endpoint distances below some thresholds given. For example, a method has been proposed which approached the problem by analyzing the connectivity pattern of the centerline nodes, and the angles formed by the query node and its two neighboring nodes. These methods may not perform well when the input data is incomplete or when complex piping systems clutter the scenes. There has also been proposed a graph-based method whose nodes were the detected pipe segments and connectors, and the edge weights were defined by the nodes' pairwise Euclidean distances. This systematic method could deal with complex piping systems; however, the graph was constructed purely based on the results from the preceding DeepPipe neural network processing and did not involve any interpolation analysis to maximize the piping system completeness when the input data was incomplete.

Accordingly, in relation to BIM reconstruction of piping system, existing or conventional methods have been found to have a number of problems including:
Geometric point features are required, e.g., point normal or curvatures, and therefore pre-processing of the input point cloud is needed. This very first step of feature computation can be error-prone and may affect later steps. The additional processing increases the computational time as well.
Parameter tuning is required, e.g., the granularity for Hough space, and the neighborhood size for feature computation, object segmentation and primitive fitting. Wrong parameters can impact both the algorithm accuracy and execution time. Furthermore, setting these scene-dependent parameters is not straightforward for inexperienced users.
Prior assumptions or knowledge are applied, e.g., Manhattan-world assumption on pipe directions, pipe radius ranges, and existing 3D drawings or item lists. However, in many application cases, the prior knowledge is not available, and the assumption may not always be true, for example some sewage pipes in buildings are purposely designed with a mild slope to ensure the fluid mobility.

A need therefore exists to provide a method of BIM reconstruction for a piping system and a system thereof, that seek to overcome, or at least ameliorate, one or more deficiencies in conventional methods of BIM reconstruction for a piping system, and more particularly, to improve efficiency and effectiveness in BIM reconstruction for a piping system, such as an automatic BIM reconstruction of a piping system. It is against this background that the present invention has been developed.

### SUMMARY

According to a first aspect of the present invention, there is provided a method of BIM reconstruction for a piping system using at least one processor, the method comprising:
obtaining a point cloud patch with respect to a seed point for the point cloud patch from point cloud data obtained with respect to the piping system, the point cloud patch comprising the seed point and a first plurality of neighbor points with respect to the seed point;
embedding, for each of the first plurality of neighbor points, neighborhood features with respect to the neighbor point to the neighbor point to form a neighborhood feature embedded point cloud patch;
generating a point cloud sub-patch comprising a second plurality of neighbor points from the first plurality of neighbor points of the neighborhood feature embedded point cloud patch, each of the second plurality of neighbor points being determined to belong to a same pipe segment as the seed point using a first machine learning model;
determining whether the seed point is a pipe point based on the point cloud sub-patch using a second machine learning model; and
determining a pipe centerline point associated with the seed point based on the point cloud sub-patch and based on determining that the seed point is a pipe point.

According to a second aspect of the present invention, there is provided a system for BIM reconstruction for a piping system, the system comprising:
at least one memory; and
at least one processor communicatively coupled to the at least one memory and configured to perform the method of BIM reconstruction according to the above-mentioned first aspect of the present invention.

According to a third aspect of the present invention, there is provided a computer program product, embodied in one or more non-transitory computer-readable storage mediums, comprising instructions executable by at least one processor to perform the method of BIM reconstruction according to the above-mentioned first aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method of BIM reconstruction for a piping system using at least one processor, according to various embodiments of the present invention, according to various embodiments of the present invention;

FIG. 2 depicts a schematic block diagram of a system for BIM reconstruction for a piping system, according to various embodiments of the present invention;

FIG. 3 depicts a schematic block diagram of an exemplary computer system which may be used to realize or implement the system for BIM reconstruction for a piping system, according to various embodiments of the present invention;

FIG. 4 depicts a schematic flow diagram of the method of BIM reconstruction for a piping system according to various example embodiments of the present invention;

FIG. 5 depicts a schematic drawing of an example architecture of a PipeNet configured for cylindrical pipe detection, according to various example embodiments of the present invention;

FIG. 6 illustrates set abstraction (SA) and feature propagation (FP) layers in a local point embedded (LPE) of the PipeNet, according to various example embodiments of the present invention;

FIGS. 7A to 7C illustrate an example process from an input point cloud patch to a selected point cloud sub-patch output by a dynamic scale manager (DSM) of the PipeNet, according to various example embodiments of the present invention;

FIG. 8 depicts examples of simulated training data (example simulated pipes and ducts), according to various example embodiments of the present invention;

FIG. 9 shows the radii distribution of the simulated pipes, according to various example embodiments of the present invention;

FIG. 10 shows a table (Table 1) including the final composition of the training dataset for the PipeNet, according to various example embodiments of the present invention;

FIGS. 11A to 11C show an example of a small pipe (a pipe of interest) in an actual test scan data of a scene, according to various example embodiments of the present invention;

FIG. 12 illustrates a skew line distance and an intersection point in centerline connectivity reconstruction, according to various example embodiments of the present invention;

FIG. 13 illustrates the three types of joints in centerline connectivity reconstruction, according to various example embodiments of the present invention;

FIG. 14 illustrates a minimum spanning forest formation example, according to various example embodiments of the present invention;

FIG. 15 depicts visualization of neighborhood selection results from the DSM according to various example embodiments of the present invention, compared with neighborhood point selection results using the conventional k-NN method;

FIG. 16 shows the qualitative results of two models in relation to the ablation and comparison study on synthetic parallel dataset;

FIG. 17 shows a table (Table 2) summarizing the quantitative results of synthetic parallel dataset test;

FIGS. 18A to 18D show box plots of the errors of radii and centerline nodes predicted by the PipeNet on synthetic data under different scan coverage angles θ and low and high noise levels, according to various example embodiments of the present invention;

FIGS. 19A to 19D show plots of the average absolute and relative radius errors, maximum centerline endpoints displacements, and centerline angles of the final reconstructed pipe models in all the σ and θ conditions, according to various example embodiments of the present invention;

FIG. 20 shows a table (Table 3) including basic statistical information of test scenes and scan data;

FIGS. 21A to 21D show the point cloud, the predicted potential pipe points extracted by the PipeNet coarse sampling processing, the reconstructed IFC model, and the IFC model superimposed on the potential pipe points, respectively, for the lab scene, according to various example embodiments of the present invention;

FIGS. 22A to 22C show the point cloud, the predicted potential pipe points extracted by the PipeNet coarse sampling processing and the reconstructed IFC model, respectively, for the warehouse scene, according to various example embodiments of the present invention;

FIG. 23 shows a table (Table 4) including the processing time taken by the PipeNet and the model reconstruction respectively, according to various example embodiments of the present invention;

FIG. 24 shows a table (Table 5) including the results for both lab and warehouse scenes, according to various example embodiments of the present invention;

FIG. 25 shows a table (Table 6) comparing the present method against existing works;

FIGS. 26A to 26D show a close view of the IFC model superimposing on the point cloud data, a false positive pipe is generated at a lighting cable, a false positive pipe is generated at the curved portion of a phone booth, and a missed pipe, for the lab scene, according to various example embodiments of the present invention; and

FIGS. 27A to 27D show a close view of the IFC model superimposed on the potential pipe points, examples of missed pipe segments, and examples of false positives generated on the limbs of a person, for the warehouse scene, according to various example embodiments of the present invention.

### DETAILED DESCRIPTION

Various embodiments of the present invention provide a method of building information modeling (BIM) reconstruction for a piping system, and a system thereof.

For example, as explained in the background, in relation to BIM reconstruction of piping system, existing or conventional methods have been found to have a number of problems resulting in inefficiencies and ineffectiveness in BIM reconstruction for piping systems. Accordingly, various embodiments of the present invention provide a method of BIM reconstruction for a piping system and a system thereof, that seek to overcome, or at least ameliorate, one or more deficiencies in conventional methods of BIM reconstruction for a piping system, and more particularly, to improve efficiency and effectiveness in BIM reconstruction for a piping system, such as an automatic BIM reconstruction of a piping system.

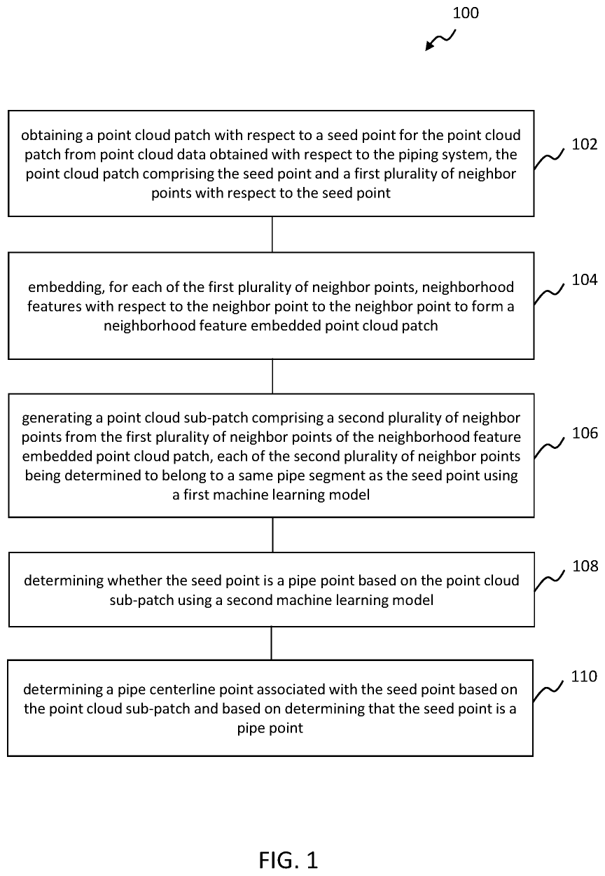

FIG. 1 depicts a schematic flow diagram of a method 100 of BIM reconstruction for a piping system using at least one processor, according to various embodiments of the present invention. The method 100 comprising: obtaining (at 102) a point cloud patch with respect to a seed point for the point cloud patch from point cloud data obtained with respect to the piping system, the point cloud patch comprising the seed point and a first plurality of neighbor points with respect to the seed point; embedding (at 104), for each of the first plurality of neighbor points, neighborhood features with respect to the neighbor point to the neighbor point to form a neighborhood feature embedded point cloud patch; generating (at 106) a point cloud sub-patch comprising a second plurality of neighbor points from the first plurality of neighbor points of the neighborhood feature embedded point cloud patch, each of the second plurality of neighbor points being determined (e.g., predicted) to belong to a same pipe segment as the seed point using a first machine learning model; determining (at 108) whether the seed point is a pipe point based on the point cloud sub-patch using a second machine learning model; and determining (at 110) a pipe centerline point associated with the seed point based on the point cloud sub-patch and based on determining that (at 108) the seed point is a pipe point (e.g., if it is determined (at 108) that the seed point is a pipe point).

In various embodiments, the above-mentioned neighborhood feature embedded point cloud patch may thus comprise the seed point and the first plurality of neighbor points, each neighbor point having embedded thereto neighborhood features with respect to the neighbor point.

In various embodiments, points (or neighbor points) belonging to the same pipe segment may refer to points belonging to a common part, section or portion of a pipe. For example, in the case of two points belonging to two adjacent pipes respectively, these two points do not belong to the same pipe segment since the two adjacent pipes are different parts of a piping system. As another example, in the case of two points belonging to two sections (or portions) at different sides, respectively, of a pipe having a form of a 90-degree elbow, although such two points may belong to a same pipe, they belong to different sections (or portions) of the same pipe and thus do not belong to the same pipe segment.

Accordingly, the method 100 of BIM reconstruction for a piping system according to various embodiments of the present invention advantageously improves efficiency and effectiveness in BIM reconstruction for a piping system, such as an automatic BIM reconstruction of a piping system. In particular, by embedding, for each of the first plurality of neighbor points, neighborhood features with respect to the neighbor point to the neighbor point to form a neighborhood feature embedded point cloud patch and generating a point cloud sub-patch comprising a second plurality of neighbor points from the first plurality of neighbor points of the neighborhood feature embedded point cloud patch, each of the second plurality of neighbor points being determined to belong to a same pipe segment as the seed point using a first machine learning model, it advantageously enables, facilitates or encourages the generation of an optimized (e.g., optimal) point cloud sub-patch comprising neighbor points with neighborhood features that are more or truly relevant (e.g., belonging to the same pipe segment as the seed point), or in other words, reducing or minimizing neighbor points with neighborhood features that are not or less relevant (e.g., not belonging to the same pipe segment as the seed point). As a result, subsequent prediction processes such as determining whether the seed point is a pipe point and determining various pipe parameters based on such a point cloud sub-patch can be advantageously performed based on more accurate or relevant data (e.g., the optimized point cloud sub-patch), thereby enabling more accurate prediction results. Furthermore, advantageously, no preprocessing is needed to extract the geometric feature from the point cloud data, no assumptions are made about the pipe directions and sizes, and no prior knowledge is used such as existing BIM or CAD models or component catalog. Accordingly, the method 100 advantageously provides a fully automatic solution for BIM reconstruction for a piping system from unstructured point cloud data. These advantages or technical effects, and/or other advantages or technical effects, will become more apparent to a person skilled in the art as the method 100 of BIM reconstruction for a piping system, as well as the corresponding system for BIM reconstruction for a piping system, is described in more detail according to various embodiments and example embodiments of the present invention.

In various embodiments, the neighborhood features with respect to the neighbor point are latent space features learned with respect to a local neighborhood of the neighbor point. In various embodiments, neighbor points with respect to a query point (such neighbor points constituting or defining a local neighborhood of the query point (e.g., query neighborhood point)) may be obtained (or extracted) by using a ball query method or a k-nearest neighbors (k-NN) method with respect to the query point. According to the ball query method, for example, all points having a distance to the query point smaller than a predefined distance may be grouped to form or define the local neighborhood with respect to the query point.

In various embodiments, the above-mentioned determining (at 110) the pipe centerline point associated with the seed point comprises: determining (e.g., predicting) a pipe radius associated with the seed point based on the point cloud sub-patch using a third machine learning model; determining (e.g., predicting) a point normal associated with the seed point based on the point cloud sub-patch using a fourth machine learning model; and determining the pipe centerline point associated with the seed point based on the seed point, the pipe radius determined and the point normal determined.

In various embodiments, the method 100 further comprises determining (e.g., predicting) a pipe flow direction associated with the seed point based on the point cloud sub-patch using a fifth machine learning model.

In various embodiments, the first machine learning model is a first classification model trained to determine (e.g., predict), for each of the first plurality of neighbor points, whether the neighbor point belongs to the same pipe segment as the seed point. In various embodiments, the second machine learning model is a second classification model trained to determine (e.g., predict) whether the seed point is a pipe point based on the point cloud sub-patch. In various embodiments, the third machine learning model is a first regression model trained to determine (e.g., predict) the pipe radius associated with the seed point based on the point cloud sub-patch. In various embodiments, the fourth machine learning model is a second regression model trained to determine (e.g., predict) the point normal associated with the seed point based on the point cloud sub-patch. In various embodiments, the fifth machine learning model is a third regression model trained to determine (e.g., predict) the pipe flow direction associated with the seed point based on the point cloud sub-patch.

In various embodiments, the above-mentioned obtaining (at 102) the point cloud patch with respect to the seed point comprises extracting the plurality of neighbor points with respect to the seed point from the point cloud data using a ball query method or a k-nearest neighbors (k-NN) method.

In various embodiments, for each of a plurality of point cloud patches from the point cloud data, the method 100 performs: the above-mentioned obtaining (at 102) the point cloud patch with respect to the seed point for the point cloud patch; the above-mentioned embedding (at 104), for each of the first plurality of neighbor points, the neighborhood features with respect to the neighbor point to the neighbor point; the above-mentioned generating (at 106) the point cloud sub-patch; the above-mentioned determining (at 108) whether the seed point is a pipe point; the above-mentioned determining (at 110) the pipe centerline point associated with the seed point based on the point cloud sub-patch and based on determining that (at 108) the seed point is a pipe point; and the above-mentioned determining the pipe flow direction associated with the seed point. In this regard, the method 100 further comprises generating a centerline parameter set comprising, for each of the plurality of point cloud patches comprising the seed point determined (at 108) to be a pipe point, the pipe centerline point determined associated with the seed point for the point cloud patch, the pipe radius determined associated with the seed point for the point cloud patch and the pipe flow direction determined associated with the seed point for the point cloud patch. In this regard, the pipe radius determined and the pipe flow direction determined based on the point cloud patch are associated with the pipe centerline point determined based on the point cloud patch. Accordingly, in various embodiments, only pipe parameters associated with seed points determined (or predicted) at 108 to be pipe points are included in the centerline parameter set,

In various embodiments, the method 100 further comprises: generating a set of centerline candidates based on the centerline parameter set; refining the set of centerline candidates to obtain a refined set of centerline candidates; and generating a piping system model for the piping system based on the refined set of centerline candidates.

In various embodiments, the above-mentioned generating the set of centerline candidates comprises: dividing the centerline parameter set into a plurality of centerline parameter subsets based on, for each centerline point in the centerline parameter set, the centerline point and the pipe flow direction associated with the centerline point; and applying, for each of the plurality of centerline parameter subsets, line fitting to the centerline parameter subset to generate a centerline candidate associated with the centerline parameter subset to obtain the set of centerline candidates.

In various embodiments, each centerline candidate of the set of centerline candidates has associated therewith two endpoints, a direction vector, a radius and a set of inlier centerline points.

In various embodiments, the above-mentioned refining the set of centerline candidates comprises, for each of a plurality of common centerline groups in turn: setting a longest centerline candidate in the set of centerline candidates that does not yet belong to any of the plurality of common centerline groups as a seed centerline candidate associated with the common centerline group and adding the longest centerline candidate to the common centerline group; adding, for each centerline candidate in the set of centerline candidates that does not yet belong to any of the plurality of common centerline groups, the centerline candidate to the common centerline group based on determining that the centerline candidate satisfies a common centerline condition between the centerline candidate and the seed centerline candidate, and setting the added centerline candidate as a new seed centerline candidate associated with the common centerline group; and for each new seed centerline candidate that has been set in the common centerline group, in turn, adding, for each centerline candidate in the set of centerline candidates that does not yet belong to any of the plurality of common centerline groups, the centerline candidate to the common centerline group based on determining that the centerline candidate satisfies the common centerline condition between the centerline candidate and the seed centerline candidate (i.e., the new seed centerline candidate), and setting the added centerline candidate as a new seed centerline candidate (i.e., a further new seed centerline candidate) associated with the common centerline group.

In various embodiments, the common centerline condition comprises a plurality of sub-conditions comprising a first sub-condition based on an angle formed by the direction vectors respectively associated with the centerline candidate and the seed centerline candidate, a second sub-condition based on a distance between the centerline candidate and the seed centerline candidate, and a third sub-condition based on a difference between the radiuses respectively associated with the centerline candidate and the seed centerline candidate.

In various embodiments, the above-mentioned refining the set of centerline candidates further comprises applying, for each of the plurality of common centerline groups, line fitting to the common centerline group to form a refined centerline candidate associated with the common centerline group to obtain the refined set of centerline candidates.

In various embodiments, the above-mentioned refining the set of centerline candidates further comprises determining, for each of the plurality of common centerline groups, a radius associated with the refined centerline candidate associated with the common centerline group by applying circle fitting based on an extracted segment of the point cloud data corresponding to a length of the refined centerline candidate.

In various embodiments, the above-mentioned generating the piping system model comprises performing graph-based centerline connectivity reconstruction based on the set of refined centerline candidates, comprising: constructing a graph comprising a plurality of nodes for representing the set of refined centerline candidates, wherein each node represents a corresponding refined centerline candidate of the set of refined centerline candidates and each pair of nodes of the plurality of nodes has an edge weight assigned thereto; generating a minimum spanning forest comprising a plurality of minimum spanning trees based on the graph; and performing centerline connections on the set of refined centerline candidates based on the minimum spanning forest.

In various embodiments, the above-mentioned performing graph-based centerline connectivity reconstruction further comprises: determining, for each pair of nodes of the plurality of nodes, the edge weight assigned thereto based on the Euclidean distance between a pair of refined centerline candidates of the set of refined centerline candidates corresponding to the pair of nodes, scan data density at a potential connection region between the pair of refined centerline candidates, a direction angle difference between the pair of refined centerline candidates and a radius difference between the pair of refined centerline candidates.

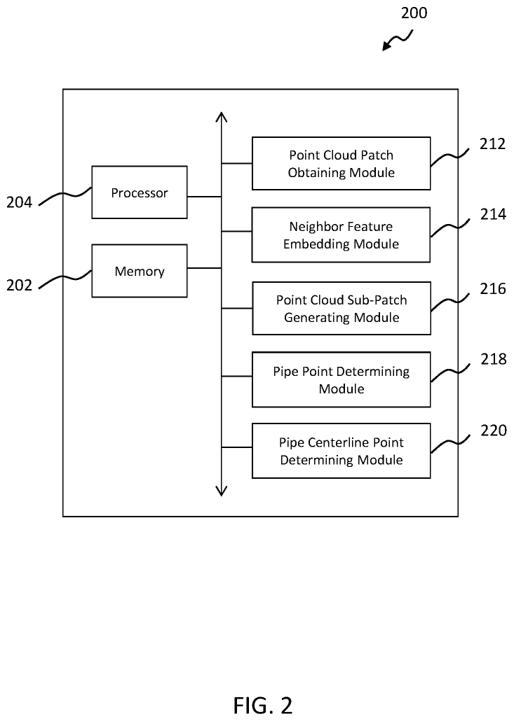

FIG. 2 depicts a schematic block diagram of a system 200 for BIM reconstruction for a piping system according to various embodiments of the present invention, corresponding to the above-mentioned method 100 of BIM reconstruction for a piping system as described hereinbefore according with reference to FIG. 1 according to various embodiments of the present invention. The system 200 comprises: at least one memory 202; and at least one processor 204 communicatively coupled to the at least one memory 202 and configured to perform the method 100 of BIM reconstruction as described hereinbefore according to various embodiments of the present invention. Accordingly, the at least one processor 204 is configured to: obtain a point cloud patch with respect to a seed point for the point cloud patch from point cloud data obtained with respect to the piping system, the point cloud patch comprising the seed point and a first plurality of neighbor points with respect to the seed point; embed, for each of the first plurality of neighbor points, neighborhood features with respect to the neighbor point to the neighbor point to form a neighborhood feature embedded point cloud patch; generate a point cloud sub-patch comprising a second plurality of neighbor points from the first plurality of neighbor points of the neighborhood feature embedded point cloud patch, each of the second plurality of neighbor points being determined to belong to a same pipe segment as the seed point using a first machine learning model; determine whether the seed point is a pipe point based on the point cloud sub-patch using a second machine learning model; and determine a pipe centerline point associated with the seed point based on the point cloud sub-patch and based on determining that the seed point is a pipe point.

It will be appreciated by a person skilled in the art that the at least one processor 204 may be configured to perform various functions or operations through set(s) of instructions (e.g., software modules) executable by the at least one processor 204 to perform various functions or operations. Accordingly, as shown in FIG. 2, the system 200 may comprise: a point cloud patch obtaining module (or a point cloud patch obtaining circuit) 212 configured to obtain a point cloud patch with respect to a seed point for the point cloud patch from point cloud data obtained with respect to the piping system, the point cloud patch comprising the seed point and a first plurality of neighbor points with respect to the seed point; a neighbor feature embedding module (or a neighbor feature embedding circuit) 214 configured to embed, for each of the first plurality of neighbor points, neighborhood features with respect to the neighbor point to the neighbor point to form a neighborhood feature embedded point cloud patch; a point cloud sub-patch generating module (or a point cloud sub-patch generating circuit) 216 configured to generate a point cloud sub-patch comprising a second plurality of neighbor points from the first plurality of neighbor points of the neighborhood feature embedded point cloud patch, each of the second plurality of neighbor points being determined to belong to a same pipe segment as the seed point using a first machine learning model; a pipe point determining module (or a pipe point determining circuit) 218 configured to determine whether the seed point is a pipe point based on the point cloud sub-patch using a second machine learning model; and a pipe centerline point determining module (or a pipe centerline point determining circuit) 220 configured to determine a pipe centerline point associated with the seed point based on the point cloud sub-patch and based on determining that the seed point is a pipe point.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, two or more modules, such as the point cloud patch obtaining module 212, the neighbor feature embedding module 214, the point cloud sub-patch generating module 216, the pipe point determining module 218 and the pipe centerline point determining module 220 may be realized (e.g., compiled together) as one executable software program (e.g., software application or simply referred to as an “app”), which for example may be stored in the at least one memory 202 and executable by the at least one processor 204 to perform various functions/operations as described herein according to various embodiments of the present invention.

In various embodiments, the system 200 for BIM reconstruction corresponds to the method 100 of BIM reconstruction as described hereinbefore with reference to FIG. 1 according to various embodiments, therefore, various functions or operations configured to be performed by the least one processor 204 may correspond to various steps or operations of the method 100 of BIM reconstruction as described hereinbefore according to various embodiments, and thus need not be repeated with respect to the system 200 for BIM reconstruction for clarity and conciseness. In other words, various embodiments described herein in context of the methods are analogously valid for the corresponding systems, and vice versa.

For example, in various embodiments, the at least one memory 202 may have stored therein the point cloud patch obtaining module 212, the neighbor feature embedding module 214, the point cloud sub-patch generating module 216, the pipe point determining module 218 and/or the pipe centerline point determining module 220, which respectively correspond to various steps (or operations or functions) of the method 100 of BIM reconstruction as described herein according to various embodiments, which are executable by the at least one processor 204 to perform the corresponding functions or operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 for BIM reconstruction described hereinbefore may include at least one processor (or controller) 204 and at least one computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM

(Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions may also be understood as a “circuit” in accordance with various embodiments. Similarly, a “module” may be a portion of a system according to various embodiments and may encompass a “circuit” as described above, or may be understood to be any kind of a logic-implementing entity.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, description or discussions utilizing terms such as “obtaining”, “embedding”, “generating”, “determining”, “extracting”, “performing”, “refining”, “dividing”, “applying”, “setting”, “adding”, “constructing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus), such as the system 200 for BIM reconstruction, for performing various operations/functions of various methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform various method steps may be appropriate.

In addition, the present specification also at least implicitly discloses a computer program or software/functional module, in that it would be apparent to the person skilled in the art that individual steps of various methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the invention. It will be appreciated by a person skilled in the art that various modules described herein (e.g., the point cloud patch obtaining module 212, the neighbor feature embedding module 214, the point cloud sub-patch generating module 216, the pipe point determining module 218 and/or the pipe centerline point determining module 220) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a computer. The computer program when loaded and executed on such the computer effectively results in a system or an apparatus that implements various steps of methods described herein.

In various embodiments, there is provided a computer program product, embodied in one or more computer-readable storage mediums (non-transitory computer-readable storage medium(s)), comprising instructions (e.g., the point cloud patch obtaining module 212, the neighbor feature embedding module 214, the point cloud sub-patch generating module 216, the pipe point determining module 218 and/or the pipe centerline point determining module 220) executable by one or more computer processors to perform the method 100 of BIM reconstruction, as described herein with reference to FIG. 1 according to various embodiments. Accordingly, various computer programs or modules described herein may be stored in a computer program product receivable by a system therein, such as the system 200 for BIM reconstruction as shown in FIG. 2, for execution by at least one processor 204 of the system 200 to perform various functions.

Software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

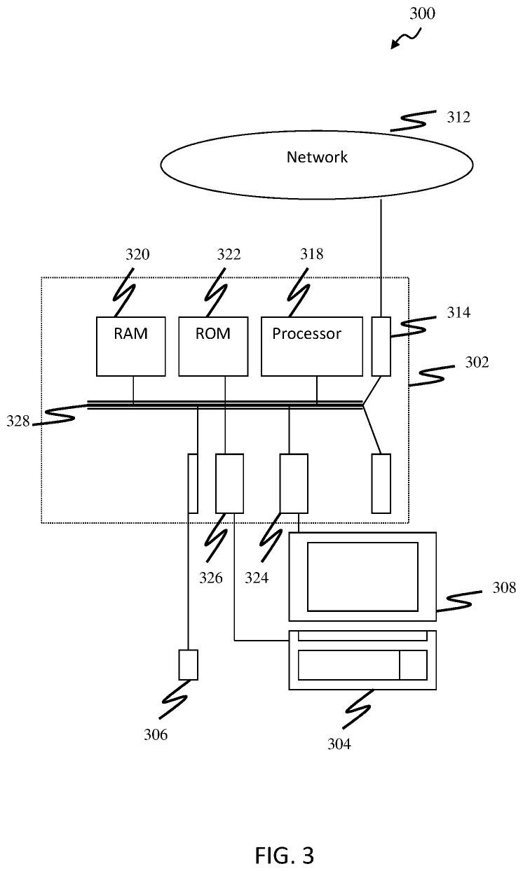

In various embodiments, the system 200 for BIM reconstruction may be realized by any computer system (e.g., desktop or portable computer system) including at least one processor and at least one memory, such as an example computer system 300 as schematically shown in FIG. 3 as an example only and without limitation. Various methods/steps or functional modules may be implemented as software, such as a computer program being executed within the computer system 300, and instructing the computer system 300 (in particular, one or more processors therein) to conduct various functions or operations as described herein according to various embodiments. The computer system 300 may comprise a system unit 302, input devices such as a keyboard and/or a touchscreen 304 and a mouse 306, and a plurality of output devices such as a display 308. The system unit 302 may be connected to a computer network 312 via a suitable transceiver device 314, to enable access to e.g., the Internet or other network systems such as Local Area Network (LAN) or Wide Area Network (WAN). The system unit 302 may include a processor 318 for executing various instructions, a Random Access Memory (RAM) 320 and a Read Only Memory (ROM) 322. The system unit 302 may further include a number of Input/Output (I/O) interfaces, for example I/O interface 324 to the display device 308 and I/O interface 326 to the keyboard 304. The components of the system unit 302 typically communicate via an interconnected bus 328 and in a manner known to a person skilled in the art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

BIM is gradually recognized and promoted as the new standard practice in the construction industry as well as the built environment. MEP system, as a system requiring regular maintenance, takes an important place in the building operation and maintenance, whereby its failure can cause significant impacts operationally, economically, and even environmentally. As-built BIM is needed for efficient BIM-enabled facility management of buildings that were built before the existence of BIM or with outdated BIM. As explained in the background, modeling of the as-built BIM is conventionally practiced in a very manual and tedious way, requiring a considerable amount of time and effort even for a skilled modeler. To address these problems associated with existing BIM reconstruction of piping systems, various example embodiments of the present invention provide a technical solution that reconstructs the as-built BIM of piping systems in buildings from LiDAR scanned point cloud data automatically. Compared to various existing works, for example, the method of BIM reconstruction of piping system(s) according to various example embodiments (which may simply be referred to herein as the present method) requires no additional data other than the unstructured point cloud with XYZ fields (i.e., a three-dimensional space of a Cartesian coordinate system with three axes, which may be referred to as x-axis, y-axis and z-axis), no data preprocessing, and no prior knowledge of the pipe directions or dimensions. According to various example embodiments, the present method comprises two stages. At a first stage, a deep learning network (which may be referred to herein as PipeNet) is provided that is able to detect pipes regardless of the size of the input data and the scale of the target scene, and predict the pipe centerline points together with other pipe parameters. In various example embodiments, the PipeNet is configured to consume the raw point cloud and output semantic labels and associated pipe parameters. At a second stage, the piping system model (which may also be referred to simply as the pipe model) is reconstructed (i.e., generating a piping system model that is a reconstruction of a physical piping system) through line fitting, refinement, and graph-based connectivity analysis constrained by domain knowledge that maximizes the coherence of the piping system model. In various example embodiments, the pipe centerlines are extracted and refined from the network prediction and their connectivity relationships are reconstructed using a systematic graph-based approach. The piping system model may then be converted to an Industry Foundation Classes (IFC) format (e.g., BIM IFC 4.0) which is neutrally acceptable in the BIM industry (i.e., a platform-neutral format used in BIM industry). That is, the reconstructed piping system model may be output in an IFC format. The present method is validated on both synthetic and actual scan data, and the results (which will be discussed in detail later below) demonstrate its robustness, fast speed, and high recognition rate and precision, thereby demonstrating the improved efficiency and effectiveness of the method of BIM reconstruction of a piping system according to various embodiments and example embodiments of the present invention.

Accordingly, various example embodiments advantageously provides a fully automatic solution to reconstruct as-built BIM of piping systems from unstructured point clouds, which requires neither data preprocessing nor any orientation or dimension assumptions. For better understanding and without limitations, the method of BIM reconstruction for a piping system will now be described in further details according to various example embodiments of the present invention.

### Intelligent and Automatic Pipe BIM Reconstruction

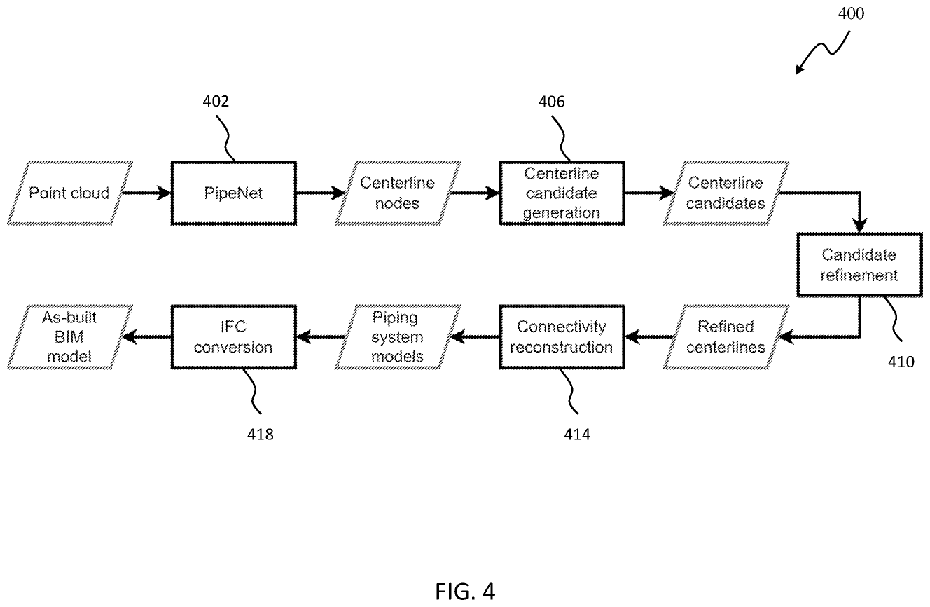

According to various example embodiments, there is provided an intelligent and automatic solution for reconstructing the as-built BIM model of piping systems from unstructured point cloud data. To maximize the generalization of the present method, advantageously, no preprocessing is needed to extract the geometric feature from the input data, no assumptions are made about the pipe directions and sizes, and no prior knowledge is used such as existing BIM or CAD models or component catalog. Various example embodiments note that a complete pipeline may be defined by consecutive centerline segments with radii parameters and connectivity relationships. In this regard, various example embodiments provide a two-stage solution for cylindrical pipe reconstruction. FIG. 4 depicts a schematic flow diagram of the method 400 of BIM reconstruction for a piping system according to various example embodiments of the present invention. As described above, at a first stage, PipeNet 402 is provided that is configured to receive raw point cloud data with XYZ fields and output the prediction of the semantic labels and the centerline nodes together with other pipe parameters (e.g., pipe radii). At a second stage, the complete pipe model(s) is reconstructed from the PipeNet predictions through a number of processes, including centerline candidate generation 406, candidate refinement 410, and graph-based connectivity reconstruction 414. Finally, the generated piping system model(s) is converted via an IFC converter 418 to a BIM IFC format.

Note that although RGB colors and intensity values besides the XYZ fields can be generated in the point clouds by most modern scanners, they are not used in the method 400 as various example embodiments note uncertainties in these two fields of information. For example, although there may be some commonly used color codes for piping systems of specific functions, such as white colors for drainage and sewage pipes, yellow for gas pipes, and red for fire sprinkler pipes, these color codes may not be adopted mandatorily and may differ from country to country. Furthermore, the pipes may intentionally be painted to be the same color as the ceilings or walls to visually minimize their existence, such as the two scenes in actual scan tests performed according to various example embodiments of the present invention (which will be discussed later below) where all the pipes are painted in black in a lab and all the fire sprinkler pipes are in white colors in a warehouse. Furthermore, the colors of pipe surfaces may decay over time due to environment influences such as the weather and the colors of pipes in the point cloud are also dependent on the scanners used and the lightings of the scenes. As for the intensity information, it may vary as well depending on the scanners used, distances of the pipes to the scanners, and the surface materials of the pipes. Because of these uncertainties, amongst various fields of information (or metadata) originally embedded in point cloud data generated by scanners, various example embodiments use only XYZ information (XYZ fields) from the point cloud data to detect pipes.

### PipeNet 402

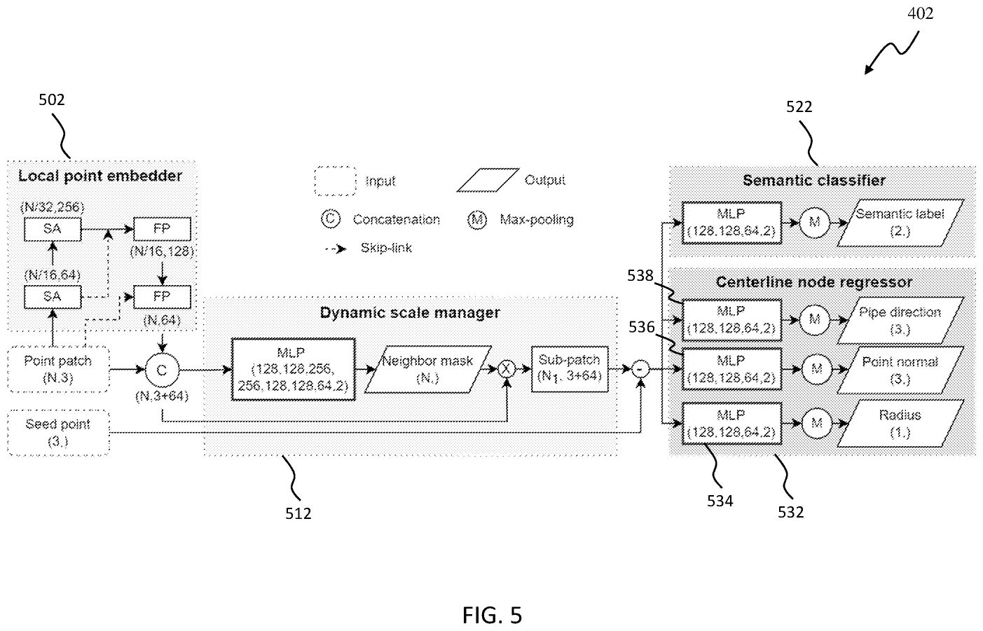

FIG. 5 depicts a schematic drawing of an example architecture of the PipeNet 402 according to various example embodiments of the present invention, which may be configured for cylindrical pipe detection. As shown in FIG. 5, the PipeNet 402 comprises two processing modules: a local point embedder (LPE) 502 (e.g., corresponding to the neighbor feature embedding module 214 as described hereinbefore according to various embodiments of the present invention) and a dynamic scale manager (DSM) 512 (e.g., corresponding to the point cloud sub-patch generating module 216 as described hereinbefore according to various embodiments of the present invention), and two output modules: a semantic classifier 522 (e.g., corresponding to the pipe point determining module 218 as described hereinbefore according to various embodiments of the present invention) and centerline node regressor 532 (e.g., corresponding to the pipe centerline point determining module 220 as described hereinbefore according to various embodiments of the present invention), which will be described in further details later below. In FIG. 5, it will be appreciated by a person skilled in the art that each number in the bracket associated with each MLP (multilayer perceptron) denote the number of output features after each respective MLP layer, the numbers in the bracket associated with each SA (set abstraction) layer and each FP (feature propagation) layer denote the number of subsampled points and the number of output features, respectively, and the numbers in the bracket associated with nodes/points denote the configuration or shape of the patch array or matrix of those nodes/points (e.g., point patch (N, 3) denotes a patch array having a configuration or shape of N×3 (N rows and 3 columns), whereby N denotes the number of nodes/points and ‘3’ denotes the number of channels of features (XYZ), and pipe direction (3) denotes a 1D array of length 3). The PipeNet 402 is configured to receive point cloud patches as input. In various example embodiments, the point cloud patches may be sampled from the raw point cloud data for each seed point pᵢ respectively using ball query. For example, to obtain each point cloud patch, neighbor points that have distances to the seed point pᵢ for the point cloud patch smaller than a predefined radius are grouped to form the spherical point cloud patch with respect to the seed point. Accordingly, each point cloud patch comprises the corresponding seed point and a plurality of neighbor points with respect to the seed point. The PipeNet 402 may thus be regarded as a multi-tasking classification network serving the seed points of the input point cloud patches.

In various example embodiments, the segmentation of pipes may be performed in a bottom-up manner by applying the PipeNet 402 to batches of point cloud patches sampled from the entire point cloud. For example, according to the bottom-up manner, for each point cloud sub-patch generated by the DSM 512, the seed point of the point cloud sub-patch is classified by the semantic classifier 522 based on the point cloud sub-patch to determine (e.g., predict) whether the seed point is a pipe point, and seed points that are determined to be pipe points may be grouped to form semantically segmented point clusters. In contrast, according to the conventional top-down segmentation, classification is performed with respect to the entire point cloud and points out of the point cloud are extracted to generate the point clusters. In various example embodiments, a coarse-to-fine strategy or technique for seed point sampling is provided to increase the implementation speed as will be described later below in the Section “Actual scan validation”. For example, comparing to existing scene segmentation networks which consume the down-sampled point clouds of either an entire scene or certain blocks cut from the scene, the PipeNet 402 is advantageously able to consume more details from the point cloud patch inputs and thus is able to detect pipes of various sizes regardless of the scales of the scenes and the sizes of raw point clouds.

### Local Point Embedder (LPE) 502

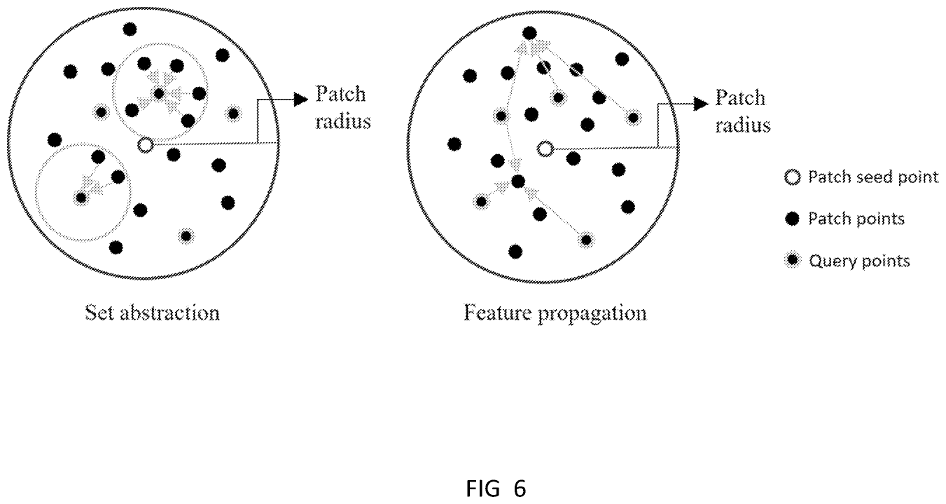

In various example embodiments, for each point cloud patch of a plurality of point cloud patches received, the point cloud patch first goes through the LPE 502 which extracts neighborhood features (which may be referred to as local neighborhood features) for each neighbor point (with respect to the seed point) in the point cloud patch individually. In particular, the LPE 502 is configured to embed, for each of a plurality of neighbor points of the point cloud patch, neighborhood features with respect to the neighbor point to the neighbor point to form a neighborhood feature embedded point cloud patch. It will be appreciated that the present invention, or more particularly, the PipeNet 402, is not restricted or limited to any point feature embedding network, as long as the point feature embedding network can be utilized to embed, for each of the plurality of neighbor points of a point cloud patch, neighborhood features with respect to the neighbor point to the neighbor point. In various example embodiments, by way of example only and without limitation, PointNet++ as described in C. R. Qi, L. Yi, H. Su, and L. J. Guibas, “PointNet++: Deep Hierarchical Feature Learning on Point Sets in a Metric Space,” June 2017, doi: 10.1016/S0039-9140(96) 02179-0, may be used due to its simplicity and successes demonstrated on various tasks such as normal estimation, object detection, and large-scene segmentation. In this regard, various example embodiments may apply the hierarchical feature learning architecture with multi-scale grouping strategy proposed in PointNet++, namely, the set abstraction (SA) and feature propagation (FP) layers, as illustrated in FIG. 6. In each SA layer, a subset of query points is randomly selected from the patch points or query points from the previous layer. For each query point, the point-wise kernel function may then take in the location offset from each neighbor point to the query point together with features of the neighbor points learned from the previous layer, if any, and feeds them to a series of 1-D (one-dimensional) convolutional layers to learn the latent space features of the local neighborhood of the query point. The FP layer propagates the features of the query points back to the input patch points using the inverse distance weighted average based on the k-NN relationship. For example, FIG. 5 illustrates an example data processing flow of the LPE 502. For example, in the example case of the LPE 502 comprising a first SA layer, a second SA layer, a first FP layer and a second FP layer, data may flow through the first SA layer, the second SA layer, the first FP layer and the second FP layer sequentially as shown in FIG. 5. The dashed arrows shown denote skip-links. For example, the first FP layer may take reference of the output from the first FP layer (i.e., not using the output features but only the location of the subsampled query points) in order to propagate the features of subsampled points in the second SA layer back to those points in the first SA layer. Accordingly, after the FP layers, each neighbor point in the point cloud patch is embedded with neighborhood features of their respective local neighborhood. As a result, the LPE module 502 embeds each patch point (e.g., each neighbor point in the point cloud patch with respect to the seed point of (or for) the point cloud patch) with rich local neighborhood information besides its original XYZ fields, and which then advantageously allows the DSM module 512 to better recognize outliers if any and the output modules (the semantic classifier 522 and the centerline node regressor 532) to make more accurate prediction according to various example embodiments of the present invention. Accordingly, for each neighbor point in the point cloud patch, the above-mentioned neighborhood features with respect to the neighbor point are latent space features learned with respect to a local neighborhood of the neighbor point. In various example embodiments, neighbor points with respect to a query point (constituting a local neighborhood of the query point (e.g., query neighborhood point)) may be obtained (or extracted) by using a ball query method with respect to the query point, such as in the same or similar manner as how neighbor points with respect to the seed point are obtained (or extracted) from the point cloud data, whereby all points having a distance to the query point smaller than a predefined distance may be grouped to form the local neighborhood with respect to the query point.

### Dynamic Scale Manager (DSM) 512

In various example embodiments, the DSM 512 may comprise a series of multilayer perceptrons (MLP) with the rectified linear unit as the activation function. In this regard, the DSM 512 may act as a binary classifier (positive or negative) predicting, for each neighbor point in the input point cloud patch, whether or not it belongs to the same pipe segment (e.g., same pipe part) as the seed point pᵢ of the input point cloud patch. In various example embodiments, neighbor points predicted as positive are regarded as the true neighbor points with respect to the seed point. These true neighbor points may thus form an optimized (e.g., optimal) point cloud sub-patch with respect to the seed point. Accordingly, in various example embodiments, the DSM 512 may be trained specifically with respect to piping system(s), such as described in detail later below in the section “Training details”. In this regard, it will be understood by a person skilled in the art that the DSM 512 being configured or trained to predict, for each neighbor point in the input point cloud patch, whether or not the neighbor point belongs to the same pipe segment as the seed point pᵢ of the input point cloud patch to form a point cloud sub-patch (i.e., the above-mentioned optimized point cloud sub-patch) would still output or generate such a point cloud sub-patch with respect to any seed point (i.e., regardless of whether the seed point is a pipe point or not), just that it is trained specifically with respect to piping system(s). In other words, such a point cloud sub-patch generated is understood to comprise a plurality of neighbor points, each being determined (or predicted) to belong to the same pipe segment as the seed point, as long as the determination (or prediction) is made by the DSM 512 configured or trained to do so as described above. In this regard, as will be described later below according to various example embodiments, it is the semantic classifier module 522 that is configured to output a prediction of whether or not the seed point pᵢ is on a pipe, that is, whether the seed point pᵢ is a pipe point. In various example embodiments, as shown in FIG. 5, a slicing operation may be performed for obtaining the point cloud sub-patch whereby a neighbor mask is multiplied with the neighborhood feature embedded point cloud patch for extracting the positively predicted neighbor points. In various example embodiments, a random N₁ number of points from the point cloud sub-patch may be selected, or in other words, the optimal point cloud sub-patch may modified or adjusted (or trimmed) to have the selected number of points. For example, this is due to GPU restriction whereby in order to deploy the network on GPU for parallel processing, the number of points in each layer has to be the same. In various example embodiments, the first three channels of the feature vectors of these sub-patch points, i.e., the XYZ fields, are translated to their location displacements from the patch seed point before feeding them to subsequent prediction modules (e.g., the semantic classifier 522 and the centerline node regressor 532). For example, as shown in FIG. 5, the sub-patch translation of the point cloud sub-patch with respect to the seed point may be performed based a minus operator. Accordingly, the DSM 512 is configured to generate a point cloud sub-patch comprising a second plurality of neighbor points from a first plurality of neighbor points of the neighborhood feature embedded point cloud patch, each of the second plurality of neighbor points being determined (or predicted) to belong to a same pipe segment (or pipe part) as the seed point using a first machine learning model, for example, a classification model trained to determine (or predict), for each of a plurality of neighbor points of a point cloud patch (e.g., the neighborhood feature embedded point cloud patch), whether the neighbor point belongs to the same pipe segment as the seed point for the point cloud point.

Accordingly, the DSM 512 is advantageous in the neighbor point extraction process because it does not require any kernel with predefined shapes and sizes. In addition, since the DSM 512 is configured to generate a point cloud sub-patch comprising a plurality of neighbor points determined (e.g., predicted) to belong to the same pipe segment as the seed point, it advantageously enables, facilitates or encourages the generation of an optimized (e.g., optimal) point cloud sub-patch comprising neighbor points with neighborhood features that are more or truly relevant, or in other words, reducing or minimizing neighbor points with neighborhood features that are not or less relevant. As a result, the point cloud sub-patch output by the DSM 512 advantageously enables subsequent prediction modules (e.g., the semantic classifier 522 and the centerline node regressor 532) to be performed based on more accurate or relevant data, thereby producing better prediction results.

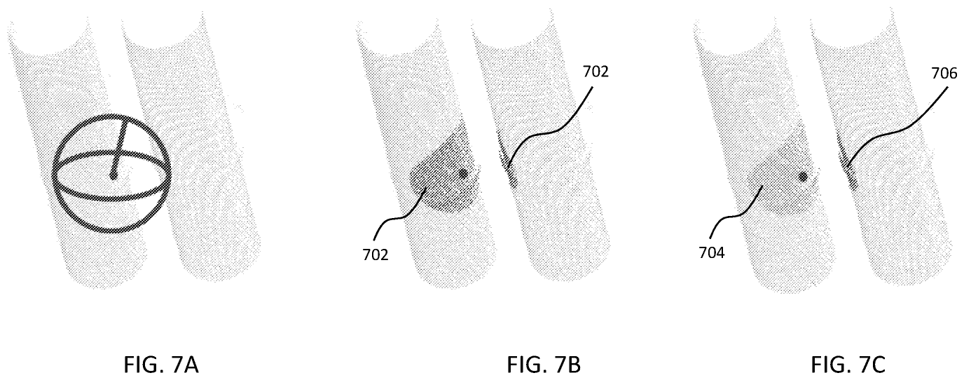

For illustration purpose only and without limitation, FIGS. 7A to 7C illustrate an example process from an input point cloud patch to a selected point cloud sub-patch (e.g., corresponding to the above-mentioned optimized point cloud sub-patch) output by the DSM 512. In particular, FIG. 7A depicts point cloud of two closely parallel pipes (belonging to different pipe segments (or parts)); FIG. 7B depicts an input point cloud patch to the DSM 512 comprising neighbor points 702 including pipe points belonging to the two closely parallel pipes, whereby the seed point for the point cloud patch is illustrated by a dark black dot (it will be appreciated by a person skilled in the art that the seed point is shown enlarged in FIGS. 7A to 7C for clarity and ease of reference only and does not have any relevance as to the size of the seed point); and FIG. 7C depicts the point cloud sub-patch (optimized point cloud sub-patch) generated by the DSM 512 (the lighter patch with the seed point) from the input point cloud patch, whereby neighbor points 704 of the input point cloud patch that are determined to belong to the same pipe segment (or part) are included in the point cloud sub-patch and neighbor points 706 of the input point cloud patch that are determined to not belong to the same pipe segment (or part) are excluded from the point cloud sub-patch 704. Accordingly, it can be seen that the DSM 512 advantageously enables, facilitates or encourages the generation of an optimized (e.g., optimal) point cloud sub-patch comprising neighbor points 704 with neighborhood features that are more or truly relevant, or in other words, reducing or minimizing neighbor points 706 with neighborhood features that are not or less relevant.

For example, when the seed point is at a cluttered area where multiple pipes exist closely such as in the example shown in FIG. 7A, using k-NN or ball query to extract neighbor points may inevitably include points from other objects (e.g., other pipe segments or parts). In this regard, various example embodiments note that those outliers can affect the accuracy of parameter prediction or estimation. Tuning the parameter of k-NN or ball query typically by reducing the k value or the ball radius may exclude the outsiders in some cases, but a number of the true pipe neighbor points may also be excluded leading to less reliable cylinder parameter estimation. In contrast, the DSM 512 according to various example embodiments of the present invention advantageously dynamically adapts to the pipes of interest by working to automatically filter out noises and outsiders while working to keep true neighbor points as much as possible. Furthermore, the DSM 512 advantageously does not rely on any fixed parameters, so task-dependent parameter tuning is not required.

### Output Module

In various example embodiments, final outputs of the PipeNet 402 are predicted based on the selected point cloud sub-patch (corresponding to the above-mentioned optimized point cloud sub-patch with the above-mentioned selected number of points) output by the DSM 512 using the semantic classifier module 522 and the centerline node regressor module 532. In various example embodiments, as mentioned above, the semantic classifier module 522 may be configured to output a binary prediction of whether or not the seed point pᵢ is on a pipe, that is, whether the seed point pᵢ is a pipe point. In various example embodiments, the centerline node regressor 532 may be configured to output or predict various pipe parameters, including the oriented point normal nᵢ (pointing to the pipe interior, i.e., inward), the pipe radius rᵢ, and the non-oriented pipe flow direction lᵢ. In this regard, various example embodiments configure the pipe radius prediction as a regression task instead of a classification task so that the application of the PipeNet 402 is not restricted to a fixed set of pipe sizes. In various example embodiments, the centerline point cᵢ (or centerline point parameter) associated with the seed point pᵢ may then be determined by:

$${c}_{i} = {p}_{i} + {n}_{i} * {r}_{i} \qquad ( 1 )$$

Accordingly, the semantic classifier module 522 (e.g., corresponding to the second machine learning model as described hereinbefore according to various embodiments) may be trained to determine (or predict) whether the seed point pᵢ is a pipe point based on the point cloud sub-patch generated by the DSM 512. In addition, the centerline node regressor 532 may comprise a pipe radius regression model 534 (e.g., corresponding to the third machine learning model as described hereinbefore according to various embodiments) trained to determine (or predict) the pipe radius (or pipe radius parameter) associated with the seed point pᵢ based on the point cloud sub-patch; a point normal regression model 536 (e.g., corresponding to the fourth machine learning model as described hereinbefore according to various embodiments) trained to determine (or predict) the point normal (or point normal parameter) associated with the seed point pᵢ based on the point cloud sub-patch; and a pipe direction regression model 538 (e.g., corresponding to the fifth machine learning model as described hereinbefore according to various embodiments) trained to determine (or predict) the pipe flow direction (or pipe flow direction parameter) associated with the seed point pᵢ based on the point cloud sub-patch. Accordingly, in various example embodiments, the pipe centerline point cᵢ associated with the seed point pᵢ may be determined (or predicted) based on the seed point pᵢ, the pipe radius rᵢ determined and the point normal nᵢ determined, such as according to the above-mentioned Equation (1).

Accordingly, for each of a plurality of point cloud patches from the point cloud data, the point cloud patch may be obtained and processed by the PipeNet 402 as described hereinbefore with reference to FIG. 5 to generate a centerline parameter set (e.g., C: {cᵢ, rᵢ, lᵢ}, which may also be referred to herein as a centerline node set) comprising, for each of the plurality of point cloud patches (e.g., each point cloud patch associated with a corresponding or respective index i) comprising the seed point determined to be a pipe point (i.e., for each point cloud patch whereby its seed point has been determined to be a pipe point by the semantic classifier 522), the pipe centerline point cᵢ determined associated with the seed point for the point cloud patch, the pipe radius rᵢ determined associated with the seed point for the point cloud patch and the pipe flow direction lᵢ determined associated with the seed point for the point cloud patch. Accordingly, in the centerline parameter set C, the pipe radius rᵢ determined and the pipe flow direction lᵢ determined based on the point cloud patch are associated with the pipe centerline point cᵢ determined based on the point cloud patch, such as based on or linked by the same index i (associated with the point cloud patch). Accordingly, in various example embodiments, only pipe parameters associated with seed points determined (or predicted) by the semantic classifier module 522 to be pipe points are included or kept in the centerline parameter set.

### Loss Function

In various example embodiments, the PipeNet 402 may be trained to minimize the multi-task loss defined in example Equations (2)-(5) below. The multi-task loss may comprise five loss terms, each term supervising one type of the output. In Equations (2)-(5) below, {{Aᵢ|i∈[0,5]}} are constant weights respectively for the five loss terms set empirically. Lᵢₙₛ and Lₛₑₘ denote losses of the neighbor mask classification of patch points by the DSM 512 and semantic classification of pᵢ by the semantic classifier 522 respectively. The classical cross-entropy loss is used for both terms. y and ŷ are the ground truth label and predicted label respectively. w denote the loss weight of each class. s(x) denotes 1 if x is true and otherwise 0. N, Nₛᵢₘ, N_{sim pipe} and Nₚₒₛ denote the total number of seed points, seed points from simulated data, seed points from simulated pipes, and number of patch points predicted as positive, respectively.

In various example embodiments, only positively predicted patch points of simulated data are counted towards Lᵢₙₛ, that is, any negatively labeled patch points being predicted as positive are penalized but not vice versa. This soft classification allows the DSM 512 to select a subset of the true neighbors (e.g., patch points from the same pipe segment (or part)) as the point cloud sub-patch. Since the DSM 512 is also co-supervised by all the other loss terms, the point cloud sub-patch is basically trained to be an optimized (e.g., optimal) neighborhood for the seed point classification by the semantic classifier 522 and cylinder parameter estimations by the centerline node regressor 532.

The normal loss, Lₙₒᵣ, is supervised by the Euclidian distance difference between the predicted normal nᵢ and the ground truth nᵢ_{_{GT}}. Lᵣ denotes the radius loss, including two terms: (1) the absolute difference and (2) the relative difference. Various example embodiments advantageously found that having such two terms help better supervise the radius regression by the pipe radius regression model 534 for both large and small pipes because a small absolute difference can cause a large relative difference for a small pipe, while a small relative difference can result in a large absolute difference for a large pipe. In various example embodiments, A₅ is applied to moderate the value of relative difference loss, otherwise the radius relative difference is observed to overwhelm all other losses at the initial training stage which can lead to loss explosion. L_{dir} denotes the pipe flow direction loss. According to various example embodiments, because the predicted flow direction is non-oriented, the minimum Euclidian distance difference between the prediction lᵢ and the ground truth lᵢ_{_{GT}} is used to calculate the pipe flow direction loss. Furthermore, all simulated data are counted towards this loss.

$$L = {A}_{0} {L}_{i n s} + {A}_{1} {L}_{s e m} + {A}_{2} {L}_{n o r} + {A}_{3} {L}_{r} + {A}_{4} {L}_{dir} \qquad ( 2 )$$

$${L}_{i n s} = - \frac{1}{{N}_{sim pipe} {N}_{p o s}} {\sum }_{i = 1}^{N} {\sum }_{k = 1}^{{N}_{p o s}} {y}_{i}^{k} log ( {\hat{y}}_{i}^{k} ) s ( {\hat{y}}_{i}^{k} == 1 ) s ( {p}_{i} ∈ sim pipe ) \qquad ( 3 )$$

$${L}_{s e m} = - {\sum }_{i = 1}^{N} {y}_{i} log ( {\hat{y}}_{i} ) {w}_{i} \qquad ( 4 )$$

$${L}_{n o r} = \frac{1}{{N}_{sim pipe}} {\sum }_{i = 1}^{N} ‖ {n}_{i} - {n}_{g {t}_{i}} ‖ s ( {p}_{i} ∈ sim pipe ) \qquad ( 5 )$$

$${L}_{r} = \frac{1}{{N}_{sim pipe}} {\sum }_{i = 1}^{N} ( ‖ {r}_{i} - {r}_{{i}_{G T}} ‖ + \frac{‖ {r}_{i} - {r}_{{i}_{G T}} ‖}{{A}_{5} {r}_{{i}_{G T}}} ) s ( {p}_{i} ∈ sim pipe ) \qquad ( 6 )$$

$${L}_{dir} = \frac{1}{{N}_{s i m}} {\sum }_{i = 1}^{N} min ( ‖ {l}_{i} - {l}_{{i}_{G T}} ‖ , ‖ {l}_{i} + {l}_{{i}_{G T}} ‖ ) s ( {p}_{i} ∈ sim ) \qquad ( 7 )$$

### Training Details

In experiments performed according various example embodiments, the PipeNet 402 is trained on both simulated dataset and open-source dataset, ScanNet (A. Dai, A. X. Chang, M. Savva, M. Halber, T. Funkhouser, and M. Nießner, “ScanNet: Richly-annotated 3D Reconstructions of Indoor Scenes,” 2017) and S3DIS (I. Armeni, S. Sax, A. R. Zamir, and S. Savarese, “Joint 2D-3D-Semantic Data for Indoor Scene Understanding,” ArXiv e-prints, February 2017). The simulated dataset is created due to the lack of MEP categories in open-source datasets. Furthermore, since the training dataset required by the network includes both semantic labels and pipe parameters, manual labeling and modeling pipes using real scanned data is not practical. According to various example embodiments, simulation of point cloud data is identified to be an ideal workaround.

In various example embodiments, the dataset simulation comprises two steps: pipe model simulation and point cloud synthesis. Both steps are implemented in BLENDER software. The MEP models are simulated using a modified pipeMare add-on. In this regard, added features include round elbows with different curvatures, multiple pipes in closely parallel arrangements, ducts with rectangular cross-section shapes. Each model contains pipes and/or ducts arranged in 2-4 layers along the depth axis within an area of 5 m by 5 m. The radii range is 1-20 cm to cover the common pipe sizes in residential and commercial buildings. Each simulated pipe has a fixed radius throughout and does not have any pipe fixtures such as flanges and valves.

Point cloud synthesis is implemented using BlenSor add-on. Five scanner locations are added randomly for each model. The scanner locations are restricted at one side of the pipe model with a distance of 1-4 m. This is to simulate the actual scanning scenario where the laser scanner scans the pipes installed below ceilings or near walls. Three point cloud data are generated for each model by randomly selecting 1-3 random scans to augment the data varieties of density and scan coverage. The ground truth is generated by sampling points along the centerlines at 0.1 mm intervals and assigning to each scan point the nearest centerline point together with the corresponding radius, point normal, and pipe direction parameters. The point normal ground truth is calculated as the normalized offset vector from the scan point to the centerline point. The 0.1 mm centerline node interval size is chosen to keep the angle error of the point normal ground truth within 1 degree. For illustration purpose only, some examples of simulated training data are shown in FIG. 8. In FIG. 8, the left column is a perspective view of example simulated pipes and ducts, and the right column is a top view of the example simulated pipes and ducts. Furthermore, in FIG. 8, ground truth centerline points are also shown running through the example simulated pipes and ducts.

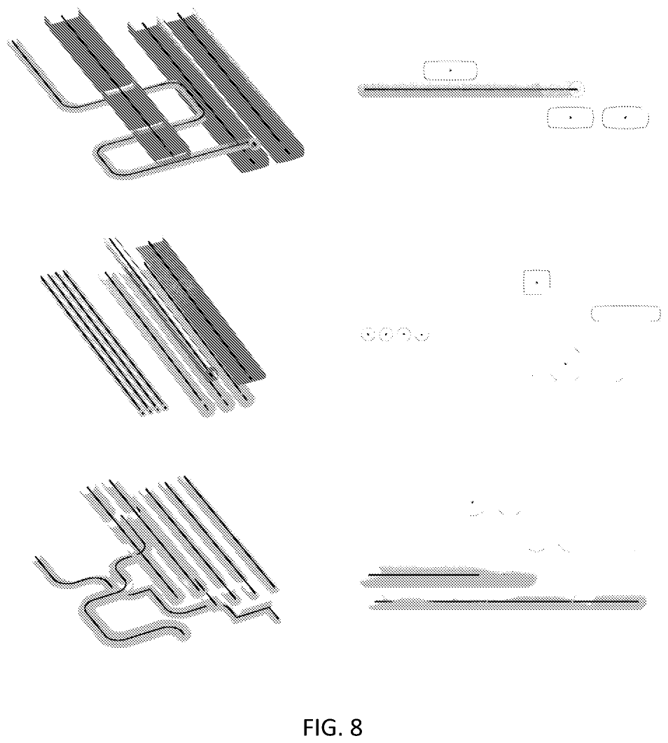

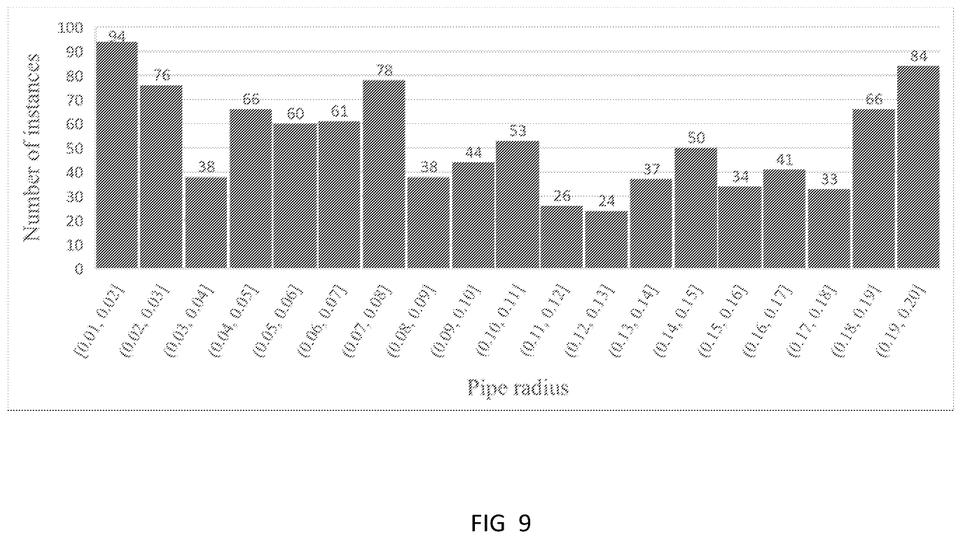

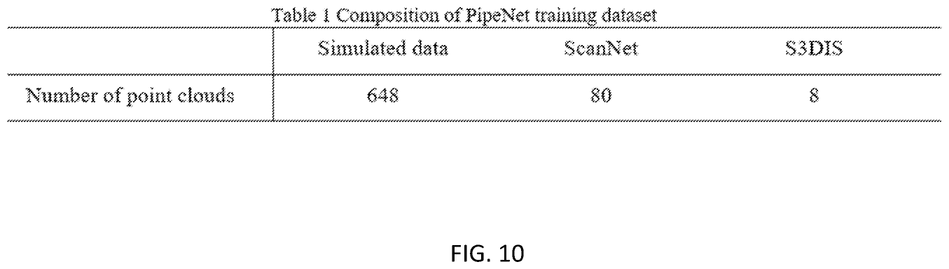

Although noise augmentation is implemented, it is noted through experiments that the PipeNet 402 trained on simulated data only may not perform well on real scans especially when the data is noisy. However, the performance is boosted according to various example embodiments after the addition of the real scan dataset, ScanNet, and S3DIS, as complementary training data. As an example, the first 100 data were used in the ScanNet and 10 toilet point clouds in the S3DIS were selected where pipes are more likely to exist. Since these two public datasets do not contain the required pipe-related ground truth, they were used as semantically negative data, i.e., they are only counted to Lₛₑₘ as the negative class. In total, 270 simulated models were created, including 1003 pipes and 616 ducts. FIG. 9 presents the radii distribution of the simulated pipes. 810 synthesized point cloud are created. 20% of point clouds were used for the network training and the rest for testing. As an example, the final composition of the training dataset for the PipeNet 402 is summarized in Table 1 in FIG. 10.

The PipeNet 402 was trained for 100 epochs with a batch size of 256 using an Adam optimizer. In each epoch, 1024 patches were sampled from each point cloud randomly. The initial learning rate was 0.001 and was decayed at a rate of 0.8 after every 4 epochs. As an example, the loss term weights used are [A₀, A₁, A₂, A₃, A₄, A₅]=[2, 2.5, 2, 0.5, 1, 20]. The training was conducted on one NVIDIA RTX A6000 GPU, and it took 22 hours in total. Because of the imbalance of numbers of non-pipes and pipes instances in the training dataset, various example embodiments applied loss weights w of 1 and 2 for pipes and non-pipes respectively in Lₛₑₘ. The input patch radius was set at 0.1 m and contained 512 points. 85 points (⅙ of the number of patch points) are selected from the point cloud sub-patch and used in the output modules. Gaussian noises are added to the data on the fly with zero mean and standard deviation σ of 1-4 mm.

### Model Reconstruction

The as-built BIM model is reconstructed from the centerline node set C: {cᵢ, rᵢ, lᵢ} predicted by the PipeNet 402 through a plurality of processes, including centerline candidate generation 406, candidate refinement 410 and connectivity reconstruction 414. In particular, according to various example embodiments, the method 400 of BIM reconstruction comprises: generating a set of centerline candidates CC based on the centerline node set C; refining the set of centerline candidates CC to obtain a refined set of centerline candidates; and generating a piping system model for the piping system based on the refined set of centerline candidates.

### Centerline Candidate Generation 406

In various example embodiments, the centerline node set C may be divided into a plurality of centerline node subsets based on, for each centerline node (which may also be referred to herein as centerline point) in the centerline node set, the centerline node and the pipe flow direction associated with the centerline node. For example, the centerline node set C may be segmented using the region growing method based on the criteria of spatial similarity and pipe flow direction lᵢ similarity. As a result, centerline node set C may thus be divided into a plurality of centerline node subsets, which may correspond to a plurality of straight segments. Subsequently, for each of the plurality of centerline node subsets, line fitting may be applied to the centerline node subset to generate a centerline candidate clᵢ associated with the centerline node subset to obtain the set of centerline candidates CC. For example, RANSAC line fitting may be applied to each cluster (centerline node subset) to generate the centerline candidate set CC. In various example embodiments, each centerline candidate clᵢ may be defined by two endpoints Eᵢ={Eᵢ¹, Eᵢ²}, unit direction (or direction vector) Dirᵢ, radius Rᵢ and a set of inlier centerline nodes Cᵢₙ. Rᵢ is an average of radii of Cᵢₙ. Various example embodiments note that although RANSAC line fitting may be directly applied to the centerline node set C to generate the centerline candidates, it is found that more computation time is required in that way and more noise candidates would be produced resulting in more workload in the subsequent processes to generate the piping system model for the piping system.

### Centerline Refinement 410

According to various example embodiments, because false positive candidates may be generated and the region growing method may over-segment a pipe into multiple candidates, candidate refinement is implemented. In various example embodiments, refining the set of centerline candidates CC comprises, for each of a plurality of common centerline groups in turn: setting a longest centerline candidate in the set of centerline candidates CC that does not yet belong to any of the plurality of common centerline groups as a seed centerline candidate associated with the common centerline group and adding the longest centerline candidate to the common centerline group; and adding, for each centerline candidate in the set of centerline candidates CC that does not yet belong to any of the plurality of common centerline groups, the centerline candidate to the common centerline group based on determining that the centerline candidate satisfies a common centerline condition between the centerline candidate and the seed centerline candidate, and setting the added centerline candidate as a new seed centerline candidate associated with the common centerline group. Furthermore, for each new seed centerline candidate that has been set in the common centerline group, in turn, adding, for each centerline candidate in the set of centerline candidates CC that does not yet belong to any of the plurality of common centerline groups, the centerline candidate to the common centerline group based on determining that the centerline candidate satisfies the common centerline condition between the centerline candidate and the seed centerline candidate (i.e., the new seed centerline candidate), and setting the added centerline candidate as a new seed centerline candidate (i.e., a further new seed centerline candidate) associated with the common centerline group. In various example embodiments, the common centerline condition comprises a plurality of sub-conditions comprising a first sub-condition based on an angle formed by the direction vectors respectively associated with the centerline candidate and the seed centerline candidate, a second sub-condition based on a distance between the centerline candidate and the seed centerline candidate, and a third sub-condition based on a difference between the radiuses respectively associated with the centerline candidate and the seed centerline candidate.

In other words, in an example implementation according to various example embodiments of the present invention, the centerline candidates in the set of centerline candidates CC may be merged iteratively as follows: the longest line candidate in the set of centerline candidates CC may be selected as the seed line clₛ∈CC. A subset of centerline candidates {clᵢ|clᵢ∈CC, [symbol] Dirᵢ, Dirₛ [symbol] <αRₛ, D (clᵢ, clₛ)<βRₛ, |Rᵢ−Rₛ|<γRₛ} (i.e., satisfying this example common centerline condition) may be added to a group (which may be referred to as a common centerline group), whereby [symbol] ⋅ [symbol] denotes the angle formed by two vectors and D(·) denotes the distance between the two candidate lines calculated by the distance from the nearest endpoint on one line to the other line. α, β, and γ are constant scalars set empirically so that all the thresholds are in terms of the candidate radius. The adaptive threshold can enhance the generalization of the algorithm in scenes of pipes with a large dimension diversity. The added centerline candidates to a group are in turn chosen as new seeds and the above step is iterated until all centerline candidates in the set of centerline candidates CC satisfying the common centerline condition have been added to a group (a common centerline group). As a result, a plurality of groups (common centerline groups) are formed, each comprising centerline candidates added thereto in the manner as described above.

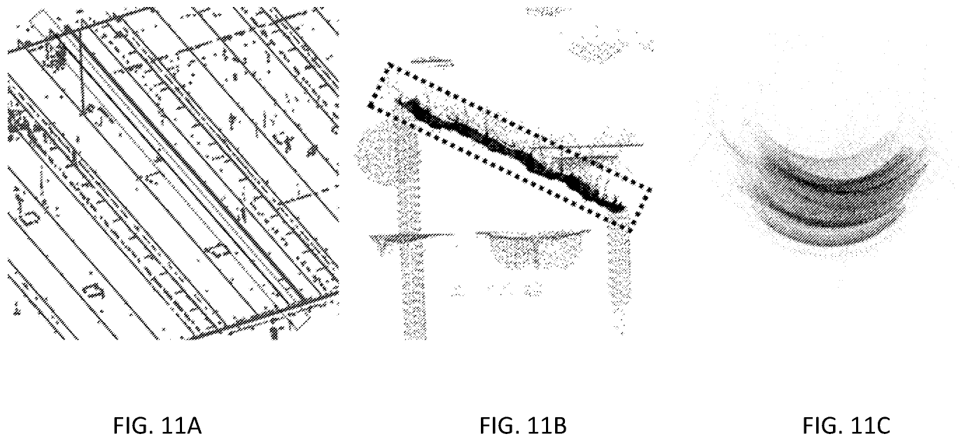

In various example embodiments, after obtaining the plurality of common centerline groups, for each of the plurality of common centerline groups, line fitting may be applied to the common centerline group to form a refined centerline candidate associated with the common centerline group to obtain the refined set of centerline candidates. For example, for each common centerline group, a refined centerline is fitted to all the inlier nodes of all centerline candidates in the group. Subsequently, for each of the plurality of common centerline groups, a radius associated with the refined centerline candidate associated with the common centerline group may be determined by applying circle fitting based on an extracted segment of the point cloud data corresponding to a length of the refined centerline candidate. For example, the least square circle fitting may be applied to refine the candidate radius using the scan data corresponding to the inlier centerline nodes. In various example embodiments, a maximum 1 m-long segment from the scan data with the best completeness is extracted for the circle fitting. In this regard, various example embodiment found that such a segment extraction is advantageously because it may not be reliable to apply the circle fitting method directly to the entire scan of the pipes that are both long in length and small in diameter. For example, pipes, such as fire sprinkler pipes with diameters of about 4-5 cm, do not exist in a perfectly straight manner but bend slightly along a length thereof because of the gravity or the position or length differences of the suspension cables. For illustration purpose, FIGS. 11A to 11C show an example of a small pipe (a pipe of interest) in an actual test scan data of a scene. In particular, FIG. 11A shows a perspective view of the pipe of interest in a distant scene, FIG. 11B shows a close-up view of the pipe of interest (the dark block pipe shown in the dotted box), and FIG. 11C shows a projection view of the pipe of interest along its first principal direction obtained by PCA. It can be seen that the projection does not exhibit a clear circular pattern. In various example embodiments, to prune noises, the refined centerlines are further examined by the length-to-radius ratio and the inlier density defined as the number of inlier nodes per unit length, as it is observed that the noise centerlines usually have poor inlier support or small length-to-radius ratios.

### Connectivity Reconstruction 414

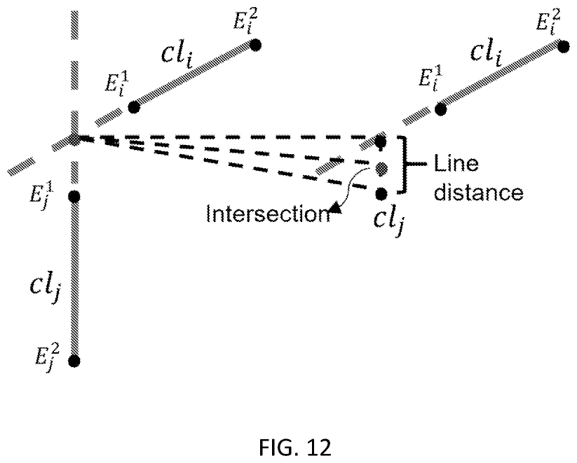

In various example embodiments, after obtaining the set of refined centerline candidates, a piping system model for the piping system may be generated, comprising performing graph-based centerline connectivity reconstruction based on the set of refined centerline candidates. In various example embodiments, performing graph-based centerline connectivity reconstruction comprises: constructing a graph comprising a plurality of nodes for representing the set of refined centerline candidates, whereby each node represents a corresponding refined centerline candidate of the set of refined centerline candidates and each pair of nodes of the plurality of nodes has an edge weight assigned thereto; generating a minimum spanning forest comprising a plurality of minimum spanning trees based on the graph; and performing centerline connections on the set of refined centerline candidates based on the minimum spanning forest. Accordingly, the centerline connectivity relationship is reconstructed, i.e., grouping centerlines in the same piping system. In various example embodiments, because the centerlines of connected pipe segments are not guaranteed to be co-planar in 3D space, the intersection points are computed as follows and as illustrated in FIG. 12, whereby both lines are extended and the nearest points on one line to the other line are found. The middle of the two nearest points is defined as the skew line intersection. In particular, FIG. 12 illustrates a skew line distance and an intersection point, whereby the left side of FIG. 12 depicts a side view and the right side of FIG. 12 depicts a top view.

In various example embodiments, in constructing the above-mentioned graph, a graph G(V, E) may be constructed to represent the set of refined centerline candidates (which may also be referred to herein as a refined centerline candidate set) where each vertex V (which may also be referred to herein as a node) corresponds to a centerline candidate (or more particularly, a refined centerline candidate). In various example embodiments, for each pair of nodes of the plurality of nodes, the edge weight assigned thereto is determined based on the Euclidean distance between a pair of refined centerline candidates of the set of refined centerline candidates corresponding to the pair of nodes, scan data density at a potential connection region between the pair of refined centerline candidates, a direction angle difference between the pair of refined centerline candidates and a radius difference between the pair of refined centerline candidates. For example, in contrast to calculating the edge weight only based on the Euclidean distances between the centerlines, various example embodiments consider additional factors including the scan data support at the potential connector area, the direction angle difference and the radius difference such as shown in Equations (8)-(11) below, where {Bᵢ|i∈{0,1,2}} are constant weights of each term, ε and θ are constant parameters set empirically, DR(Vᵢ, Vⱼ) denotes the sum of ratios of the distance between the line endpoint to the intersection point over its radius respectively, and N_{conn} denotes the number of scan data at the connector location. Accordingly, for a constant DR(Vᵢ, Vⱼ), the larger the N_{conn}, the smaller the W_{scan} is, bounded by DR(Vᵢ, Vⱼ). CA denotes a set of common connection angles used in piping systems such as 45 degrees and 90 degrees. In various example embodiments, these three factors, namely, W_{scan}, Wᵣ and W_{ang} are designed to distinguish the true connections in the cluttered areas where complex piping systems exist.

$$W ( {V}_{i} , {V}_{j} ) = {B}_{0} * {W}_{s c a n} + {B}_{1} * {W}_{r} + {B}_{2} * {W}_{a n g} \qquad ( 8 )$$

$${W}_{s c a n} = D R ( {V}_{i} , {V}_{j} ) ( {ϵ}^{- \frac{{N}_{c o n n}}{D R ( {V}_{i} , {V}_{j} )}} + 1 ) , ( ϵ > 1 ) \qquad ( 9 )$$

$${W}_{r} = \frac{\vert {R}_{i} - {R}_{j} \vert}{{R}_{l onger line}} \qquad ( 10 )$$

$${W}_{a n g} = \frac{min ( 〈 {V}_{i} , {V}_{j} 〉 - C A )}{θ} \qquad ( 11 )$$

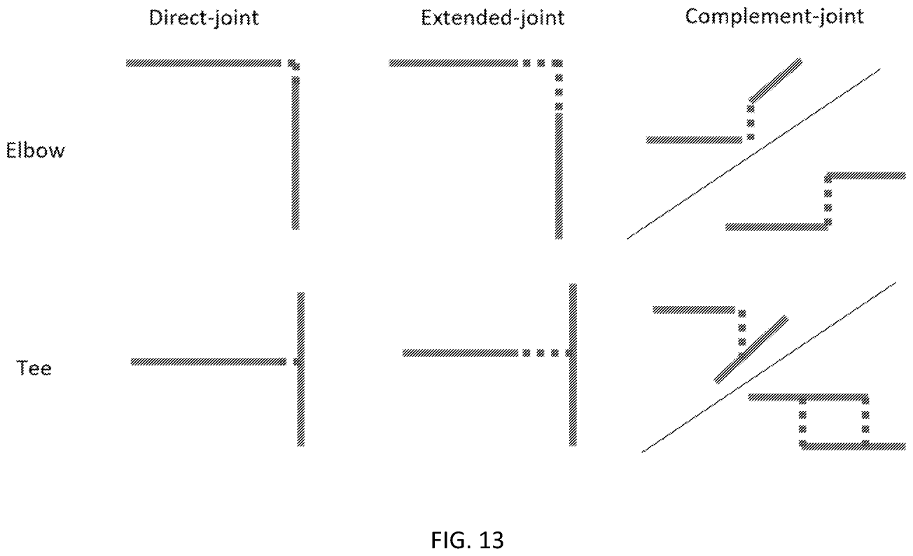

In various example embodiments, each edge may be labeled according to one of a plurality of connection types, such as direct-joint, extended-joint, and complement-joint, based on the total endpoint distance over the radius and the line distance. In various example embodiments, if the endpoints of two lines are close enough and their line distance is within a predefined threshold, the two endpoints may be labeled as direct-joint. The two endpoints may be labeled as extended-joint if the endpoint distance is further and may be labeled as complement-joint if their line distance is further. For example, the above-mentioned predefined threshold may be set by a user depending on the data quality and the scale of the scene, for example, if it is a large-scale scene and the point cloud data has a large amount of missing areas (e.g., due to occlusion), the predefined threshold may be set larger. In various example embodiments, the predefined threshold may be relative, for example, a multiplier of the radius of the longer pipe between two pipes. By way of examples only and without limitations, an example predefined threshold for the direct-joint type may be 2 (e.g. distance smaller than pipe radius×2 may be assigned as the direct-joint type), example predefined thresholds for the extended-joint threshold type may be 15 for the lab example (e.g., pipe radius×2<distance<15) and may be 25 for the warehouse example (e.g., pipe radius×2<distance<25) and an example predefined threshold for the complement joint threshold may be 1 and 20 (e.g., pipe radius×1<line distance<radius×20). It will be appreciated by a person skilled in the art that thresholds for the connection types are not limited to the example thresholds mentioned above and can be set as desired or as appropriate for the intended purpose. For example, the complement-joint type may be to recover short pipe segments that may sometimes be filtered out due to miss-classification as noises in the previous processes due to small length-to-radius ratio or not enough centerline node support. For illustration purposes, FIG. 13 illustrate the above-mentioned three types of joints. In various example embodiments, in the graph-based centerline connectivity reconstruction, amongst the above-mentioned three types of joints, direct-joint edge is prioritized over the other two types. In various example embodiments, a minimum spanning forest comprising multiple minimum spanning trees (MST) is computed from the graph sequentially following joint priority (i.e., in the priority order (starting with highest priority) of direct-joint edge→extended-joint edge→complement-joint edge). In various example embodiments, certain constraints based on domain knowledge of piping system design are applied in the MST calculation to maximize completeness, such as including the following:
i. Each endpoint of a centerline can be jointed with maximally 2 other centerlines.
ii. Two closely parallel centerlines with similar radii are mutually exclusive if they are not direct-jointed, i.e., they should reside in different trees (by way of example only and without limitation, a threshold of 0.1 may be set for radius similarity (meaning that the radii difference should be smaller than 0.1 of the radius of the longer pipe between the two pipes) and a threshold of 6 may be set for the closeness of the two parallel centerlines. It will be appreciated by a person skilled in the art that thresholds for the radius similarity and the centerlines closeness are not limited to the example thresholds mentioned above and can be set as desired or as appropriate for the intended purpose).
iii. If a pair of connected centerlines each has a mutual exclusive line, these two exclusions should be connected as well if there is an edge between them regardless of the edge weight and type. The two connected pair of centerlines should not collide with each other.
iv. Each tree formed inherits the exclusions of all of its member nodes, i.e., exclusive lines of all member nodes cannot be added to the tree.

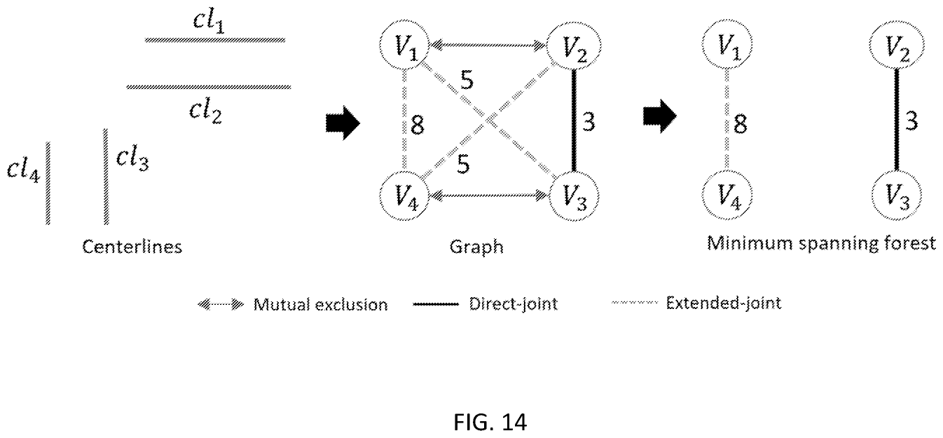

For better understanding and illustration purpose, FIG. 14 illustrates a minimum spanning forest formation example according to various example embodiments of the present invention. As shown in FIG. 14, each centerline clᵢ becomes a node in the graph (e.g., associated or denoted with the same index i). The edge weights W(Vᵢ, Vⱼ) are determined according to Equations (8)-(11) above. Note that the edge weights shown in FIG. 14 are for illustration only and may not be the actual edge weights determined according to Equations (8)-(11) above. That is, for illustration purpose and simplicity, the edge weights are shown roughly corresponding to the endpoint distances between each pair of centerlines. Following the above-mentioned constraint (ii), cl₁ and cl₂ are mutual exclusive because they are closely parallel and with similar radii, and the same for cl₃ and cl₄. Thereafter, the prioritized direct-joint edges are checked, so E_{2,3} is selected. Then, following the above-mentioned constraint (iii), the exclusions of cl₂ and cl₃, i.e., cl₁ and cl₄, are also connected because there is an edge E_{1,4} between them. Next, the extended-joint edges are examined from the ones with smallest edge weights. Because of the exclusion inheritance by the above-mentioned constraint (iv), E_{1,3} and E_{2,4} are not selected. As a result, two minimum spanning trees forming a minimum spanning forest are generated as shown in FIG. 14. In various example embodiments, each minimum spanning tree may be further examined and filtered if it has too many unusual connection angles or too few inlier centerline nodes on average. After performing this graph-based centerline connectivity reconstruction, the piping system model generated may then be converted to IFC format.

### Experiment and Validation

Validation of the method of BIM reconstruction of piping system(s) according to various example embodiments (which may simply be referred to herein as the present method) on both synthetic and actual scan datasets will now be presented and discussed. The synthetic dataset allows experiments under different controlled conditions and the generation of quantitative results. In the experiments, augmentation to the synthetic data is two-fold: scan coverage angle variation and noise addition. The point cloud of each pipe is cropped to make the scan coverage angle θ capped at 60° to 180° with a step of 60°. Gaussian noises are added with zero mean and standard deviation σ equal to 0.5% to 2% of the pipe radius respectively.

### DSM Validation

FIG. 15 depicts visualization of neighborhood selection results generated by the DSM 512 according to various example embodiments of the present invention, compared with neighborhood point selection results generated using the conventional k-NN method. In the neighborhood point selection results shown in FIG. 15, each seed point is illustrated by a dark black dot (it will be appreciated by a person skilled in the art that each seed point is shown enlarged in FIG. 15 for clarity and ease of reference only and does not have any relevance as to the size of the seed point). In FIG. 15, the first column shows the input point cloud patches obtained by the ball query method (i.e., the selected neighbor points gathered by the ball query method) using a radius of 0.1 m, the second column and the third column show the neighborhood point selection results (i.e., the selected sub-patch points) using the conventional k-NN method (where k=85, the same as the PipeNet setting described hereinbefore in the Section “Training details”) and the DSM 512, respectively, whereby the neighborhood point selection results (selected or predicted true neighbor points) are shown in dark black colour and the filtered points (filtered out) are shown in grey colour. Accordingly, the output from the DSM 512 is visualized to validate if the DSM 512 indeed learns to distinguish neighbor points from different objects (i.e., different pipe segments or parts), as shown in FIG. 15. The first two rows shows result on synthetic data and the bottom two rows show results on actual scan data. From FIG. 15, it can be seen that the DSM 512 is effective in excluding (filtering out) points from foreign objects (i.e., neighbor points not belonging to the same pipe segment as the seed point) while keeping the most true neighbor points (i.e., neighbor points belonging to the same pipe segment as the seed point). In FIG. 15, there is shown an example input patch comprising a 90-degree elbow, and the DSM 512 determined or predicted the points on the other side of the elbow (the other side with respect to the seed point) as outliers, although they are from the same piping system. That is, the DSM 512 successfully predicted those points as not belong to the same pipe segment (or pipe part). This is in line with expectations since the pipe parameter estimation only depends on the points from the same pipe segment or cylinder as the seed point.

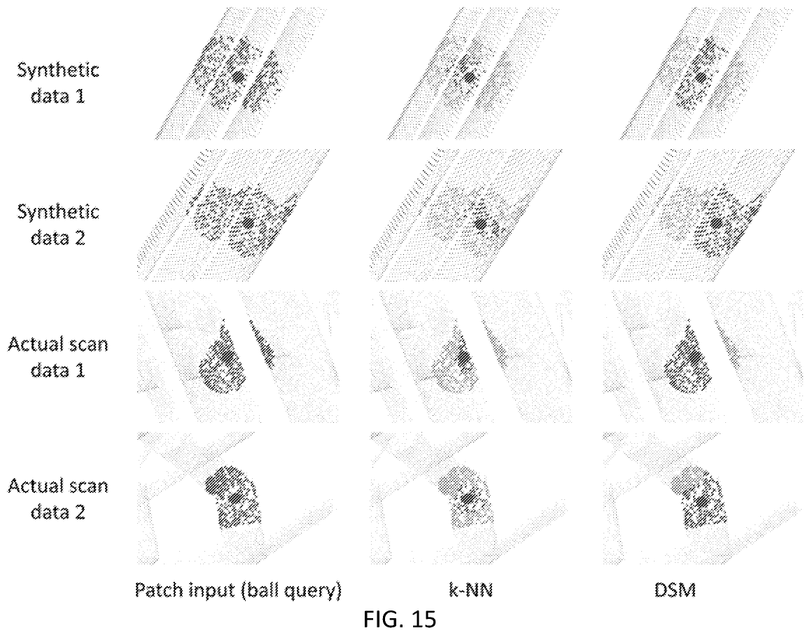

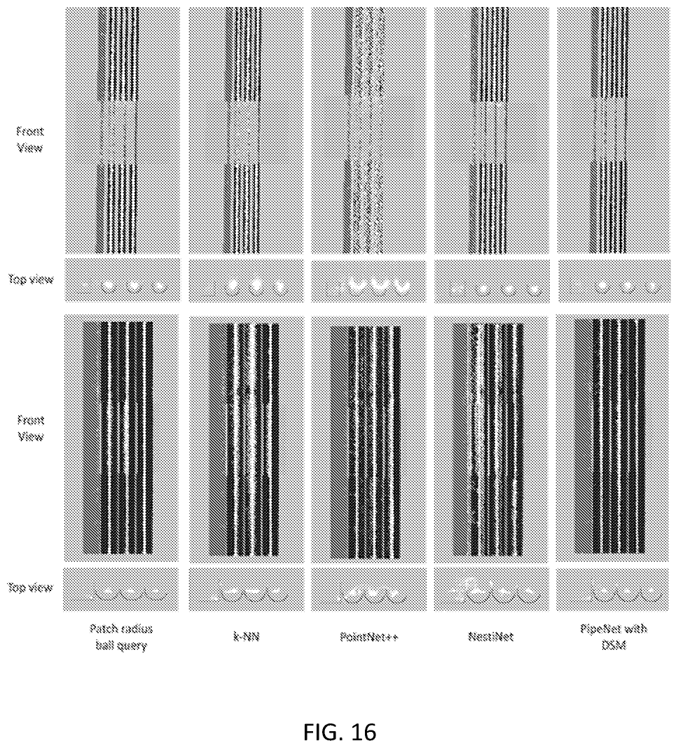

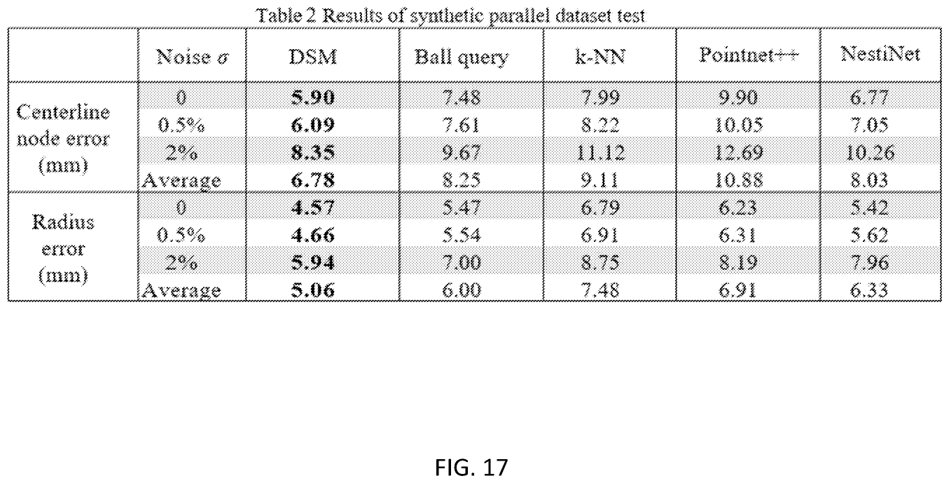

The DSM 512 is further evaluated through comparison with ablation networks, namely, the baseline network PointNet++ and NestiNet. Two ablation networks are created by replacing the DSM 512 with the k-NN and ball query methods while keeping the rest of the network structure and parameters the same. In various example embodiments, since the input to the PipeNet 402 is a patch point cloud obtained by ball query, the ball query neighbor point selection is basically randomly sampling a subset in the input patch. The PointNet++ multi-scale classification network model is used for the comparison. Both PointNet++ and NestiNet have the final fully connected layers duplicated to generate the same outputs as the present PipeNet 402. The synthetic dataset used in the validation includes 20 models of pipes and ducts with dimensions from 2 cm to 40 cm with a step of 2 cm. In each model, three pipes and one duct of the same dimension (diameter in terms of pipes and width and height in terms of ducts) are arranged in parallel with a spacing of 3 cm in between. A plane was also created behind the pipes and ducts to simulate the actual environment where the pipes and ducts are installed near the walls or ceilings. Three scans are synthesized for each model following the procedures described hereinbefore in the Section “Training details”. FIG. 16 shows the qualitative results of two models with dimensions of 4 cm and 38 cm, respectively, in relation to the ablation and comparison study on the synthetic parallel dataset. In FIG. 16, the pipe points are in dark black color, the duct points are in dark grey color, the plane points are in light grey colour, and the predicted pipe centerline points are in white colour. It can be seen that the centerline point prediction of the PipeNet 402 according to various example embodiments of the present invention is cleaner and less deviated compared to the other methods shown. FIG. 17 shows a table (Table 2) summarizing the quantitative results of synthetic parallel dataset test. It shows that under all noise levels, the PipeNet 402 according to various example embodiments of the present invention can predict consistently more accurate centerline nodes and pipe radii, with an improvement of 15.5% to 37.6% for centerline point prediction and an improvement of 15.7% to 32.4% for radius prediction on average.

### Sensitivity Analysis

The sensitivity of the present method to the scan coverage angle and noise are evaluated. The synthetic dataset used for the sensitivity analysis consists of models of standalone straight pipes with radii from 1 cm to 20 cm with a step of 1 cm. The point cloud synthesis procedure remains the same as described hereinbefore in the Section “Training details”. Robustness to the variation of scan coverage angle can be important since real pipes may usually be installed next to walls or ceilings, or in confined spaces, so that partial visibility in the scan data may be inevitable and may affect the reconstruction result.

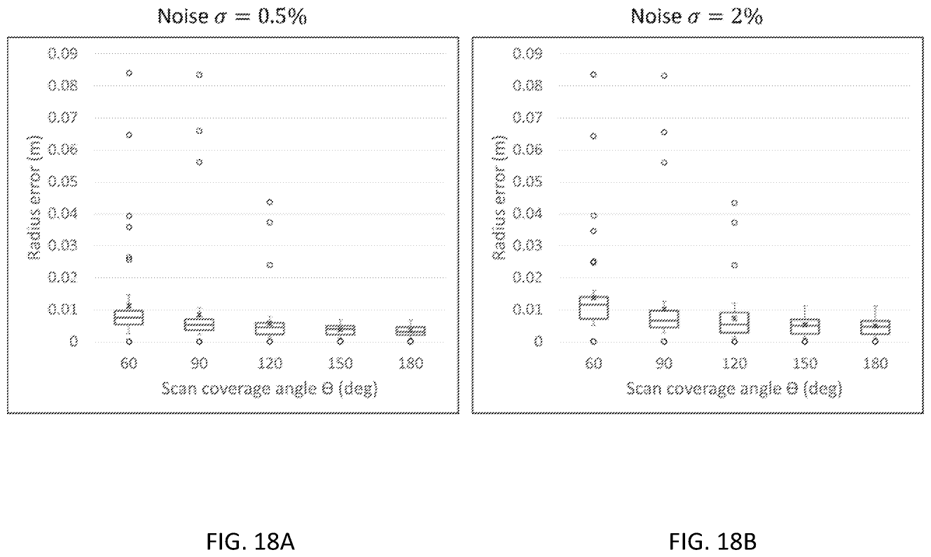

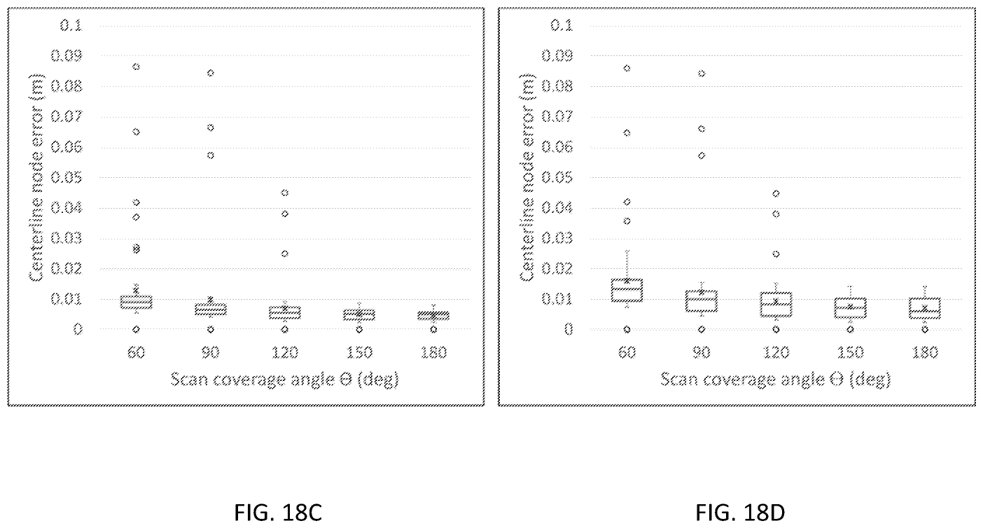

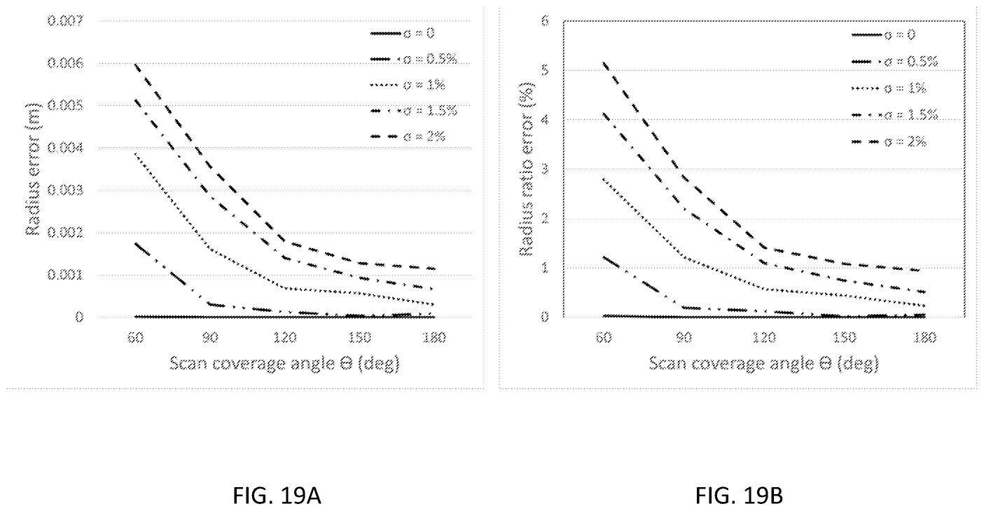

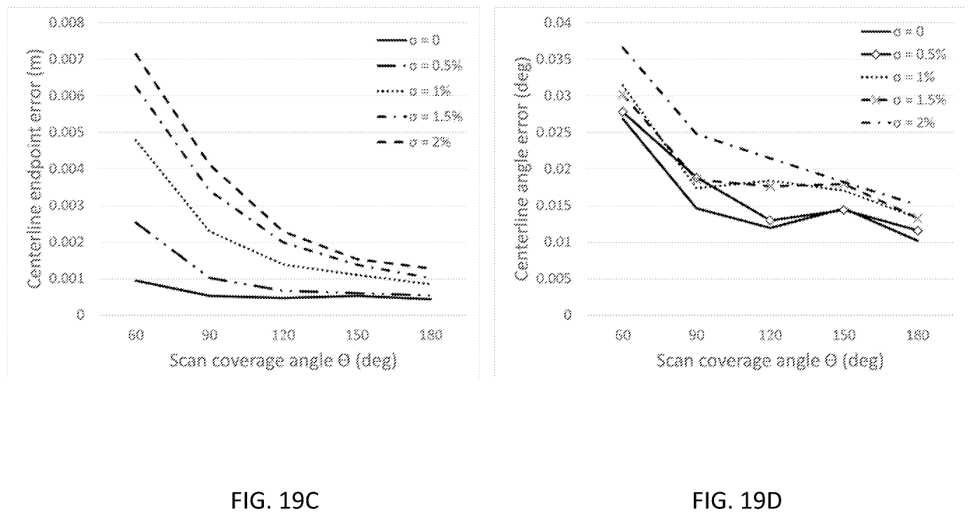

Both the accuracy of the PipeNet prediction and the reconstruction are tested. FIGS. 18A to 18D show box plots of the errors of radii and centerline nodes predicted by the PipeNet 402 on synthetic data under different scan coverage angles θ and low and high noise levels. The horizontal axis represents scan coverage angle θ. FIGS. 18A and 18C correspond to low σ=0.5% and FIGS. 18B and 18D correspond to high σ=2% noise level. It can be observed that both errors decrease as θ increases from 60° to 120° and then remains rather stable in the following θ cases. As expected, the errors and error distributions both increase in the high noise case. Several outliers are observed in cases of θ from 60° to 120°. The outliers are from pipes with the two smallest radii (1-2 cm) for θ=60°, and pipes with radii of 1 cm for θ={90°, 120°}. FIGS. 19A to 19D show plots of the average absolute and relative radius errors, maximum centerline endpoints displacements, and centerline angles of the final reconstructed pipe models in all the σ and θ conditions. Each curve corresponds to a different noise level σ and the horizontal axis represents the scan coverage angle θ. The unit of angle error is degree. The errors generally decrease with larger θ and smaller σ and remain at a fairly low level in conditions of θ≥120°, proving the present method's robustness. However, it is noted that the present method according to various example embodiments may not be able to reconstruct pipes with radii of 1 cm with θ≤120° and pipes with radii of 2 cm when θ=60°. To address this, for small pipes with radii no more than 2 cm, various example embodiments capture them with a scan coverage angle larger than 120° to ensure successful detection and reconstruction.

### Actual Scan Validation

### Data and Test Details

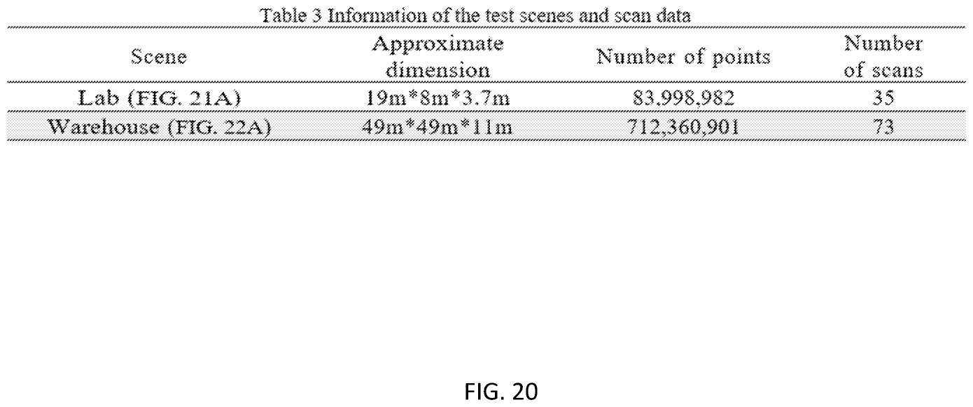

The present method is tested on two actual scan data. The first scene is a research lab at the Nanyang Technological University. It is a fully operational lab with furniture and staff working around. The second scene is an empty warehouse. The basic statistical information of the test scenes and the scan data are summarized in Table 3 in FIG. 20. The tests are conducted using one NVIDIA RTX A6000 GPU. In the implementation of the PipeNet 402, two rounds of seed point sampling with coarse and fine grid sizes respectively are adopted. The grid size in the coarse sampling round (or first sampling round) is 0.1 m. Only the patch points of those seed points that are semantically predicted as pipes are kept and involved in the fine sampling round (or second sampling round). That is, at the coarse sampling round, seed points are sampled from the input raw point cloud data with a large seed point sampling grid size. Then, all seed points that have been predicted as pipe points, together with their point cloud patch points, are obtained and provided to the fine sampling round (i.e., corresponding to the coarse-to-fine strategy for seed point sampling mentioned hereinbefore). The coarse sampling acts as rapid screening of the input point clouds to isolate the potential pipe points and thus greatly reduce the total implementation time. In the fine sampling round, a smaller grid size of 0.02 m is used to examine the potential pipe data in detail and predict the final pipe points and their centerline nodes together with other pipe parameters. In various example embodiments, the above-mentioned prediction is also performed using the PipeNet 402. Accordingly, in various example embodiments, the PipeNet 402 may be implemented at the coarse sampling round (which may be referred to as the PipeNet coarse sampling round) and then subsequently at the fine sampling round (PipeNet fine sampling round). Results from the fine sampling round are used in the subsequent model reconstruction stage.

### Results

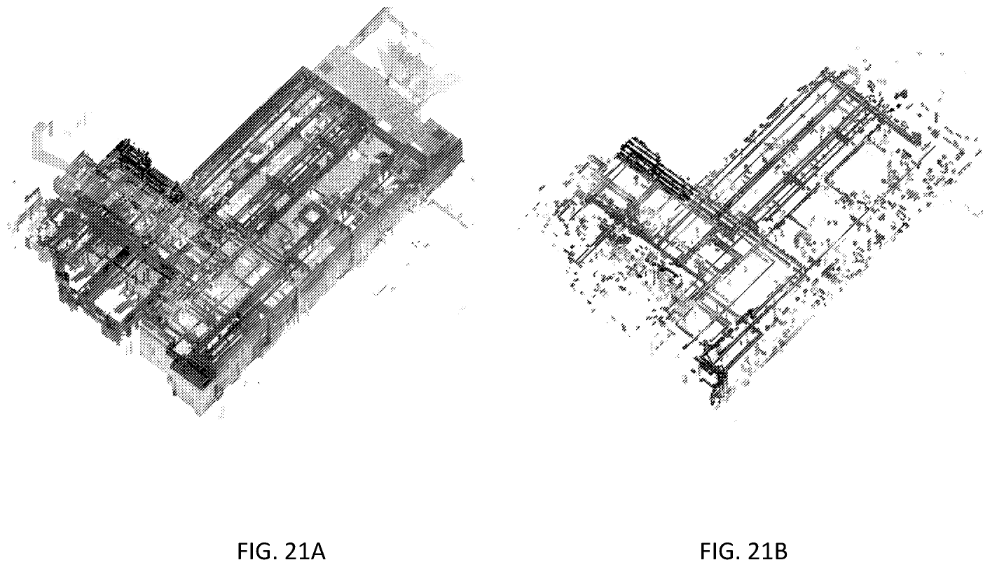

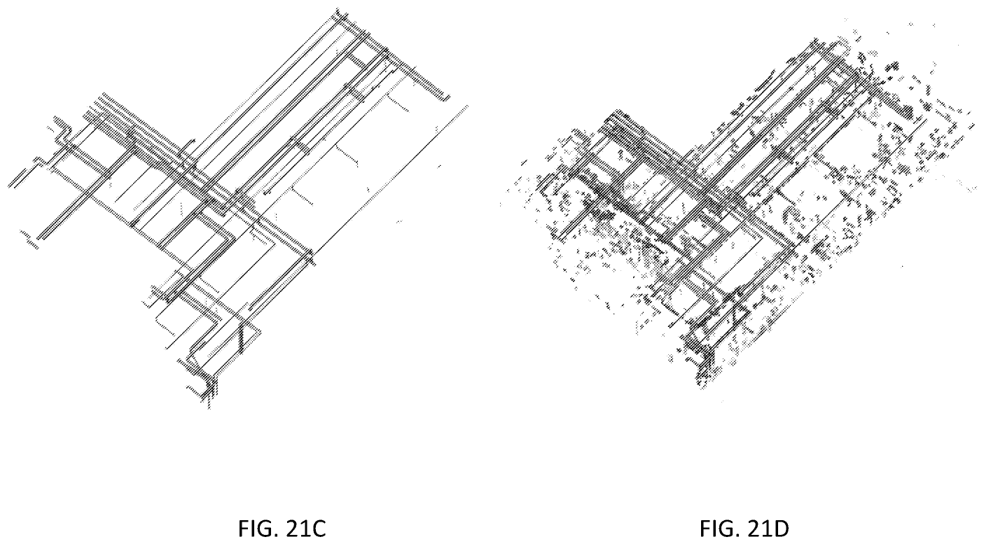

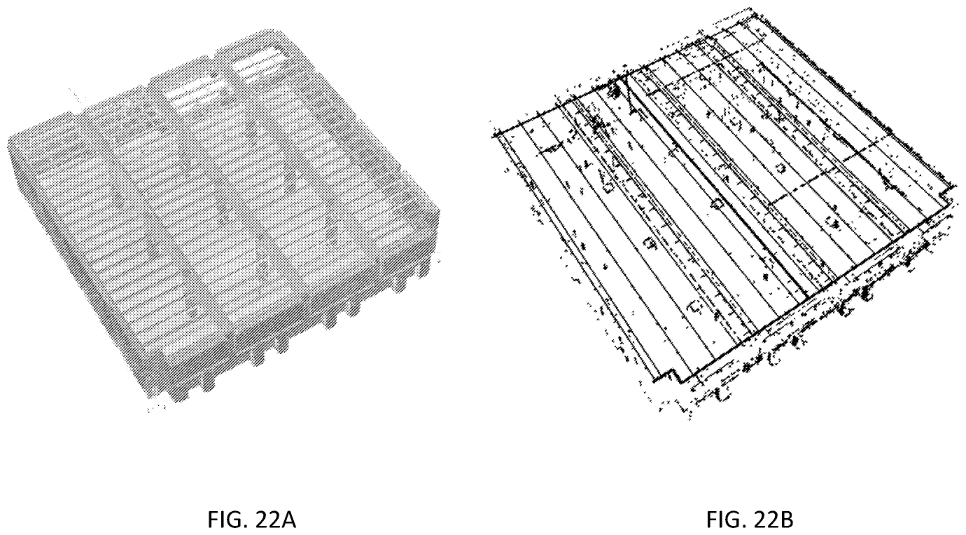

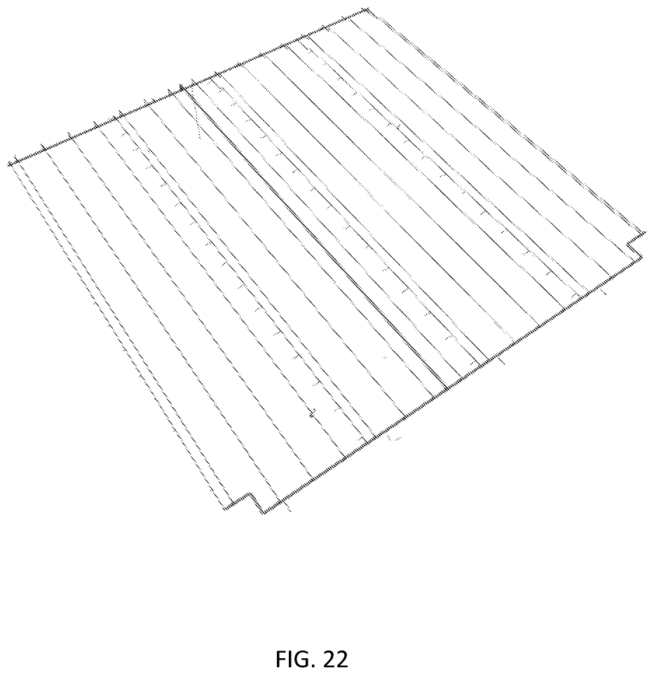

FIGS. 21A to 21D show the point cloud (the ceiling is manually removed for better visualization of the interior), the predicted potential pipe points extracted by the PipeNet coarse sampling processing, the reconstructed IFC model, and the IFC model superimposed on the potential pipe points, respectively, for the lab. FIGS. 22A to 22C show the point cloud (the ceiling is manually removed for better visualization of the interior), the predicted potential pipe points extracted by the PipeNet coarse sampling processing and the reconstructed IFC model, respectively, for the warehouse. Because the area of the warehouse is large, the scanning was conducted without color to save time. For example, comparing FIG. 21A and FIG. 21B, it can be seen that the PipeNet coarse sampling effectively removes a large portion of the data points that belong to the structure objects and the furniture.

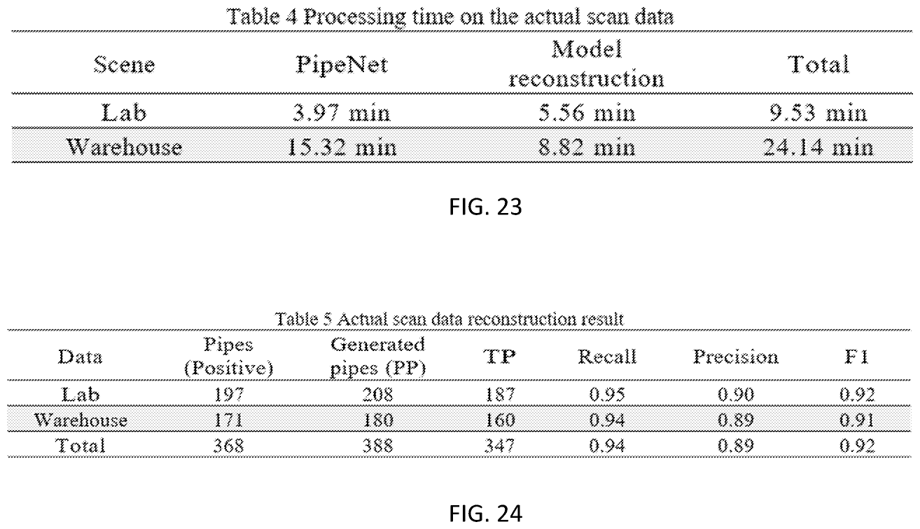

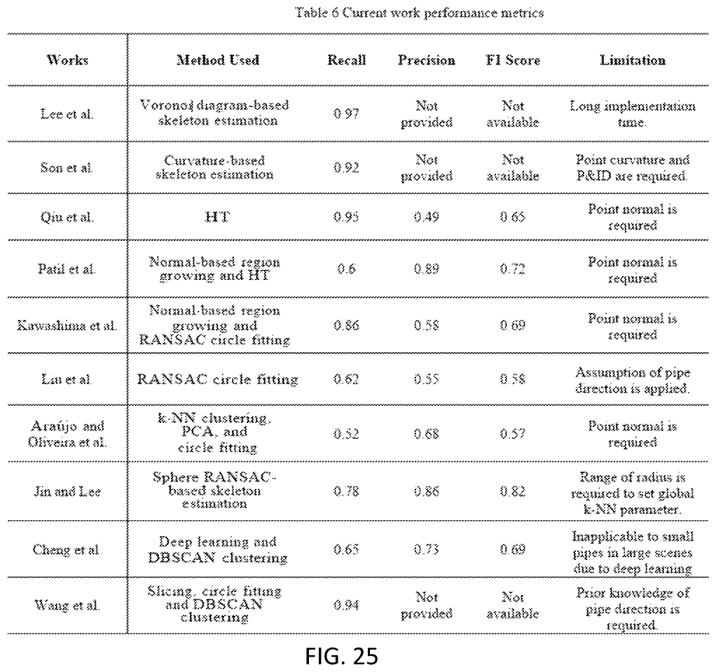

The processing time taken by the PipeNet 402 and the model reconstruction respectively are provided in Table 4 in FIG. 23. Various example embodiments evaluate the reconstruction results using recall, precision, and F1 scores, as defined in Equations (12)-(14) below. The results for both scenes are summarized in Table 5 in FIG. 24. For the lab scene, 187 out of the 197 pipes are successfully reconstructed, while 11 false positives are created. The recall, precision, and F1 score are computed as 0.95, 0.90, and 0.92. For the warehouse scene, 160 out of 171 pipes are successfully reconstructed while 9 false positives are created. The recall, precision, and F1 score are computed as 0.94, 0.89, and 0.91. Accordingly, it is demonstrated or validated that the present method can reconstruct pipes efficiently and robustly even in cluttered and large-scale scenes. For example, compared with existing works listed in Table 6 in FIG. 25, although the test data used are different, the present method achieves the third-best recall rate and the best precision and F1 scores. In particular, Table 1 includes the following existing works: Lee et al. (J. Lee, H. Son, C. Kim, and C. Kim, “Skeleton-based 3D reconstruction of as-built pipelines from laser-scan data,” Autom. Constr., vol. 35, pp. 199-207, 2013, doi: 10.1016/j.autcon.2013.05.009), Son et al. (H. Son and C. Kim, “Automatic segmentation and 3D modeling of pipelines into constituent parts from laser-scan data of the built environment,” Autom. Constr., vol. 68, pp. 203-211, 2016, doi: 10.1016/j.autcon.2016.05.010), Qiu et al. (R. Qiu, Q. Zhou, and U. Neumann, “Pipe-Run Extraction and Reconstruction,” in Computer Vision—ECCV 2014, 2014, no. Springer International Publishing Switzerland, pp. 17-30, doi: 10.1007/978-3-319-10578-9_2), Patil et al. (A. K. Patil, P. Holi, S. K. Lee, and Y. H. Chai, “An adaptive approach for the reconstruction and modeling of as-built 3D pipelines from point clouds,” Autom. Constr., vol. 75, pp. 65-78, 2017, doi: 10.1016/j.autcon.2016.12.002), Kawashima et al. (K. Kawashima, S. Kanai, and H. Date, “As-built modeling of piping system from terrestrial laser-scanned point clouds using normal-based region growing,” J. Comput. Des. Eng., vol. 1, no. 1, pp. 13-26, 2014, doi: 10.7315/JCDE.2014.002), Liu et al. (L. Yong Jin, Z. Jun-bin Bin, J. C. Hou, J. C. Ren, and W. Q. Tang, “Cylinder Detection in Large-Scale Point Cloud of Pipeline Plant,” IEEE Trans. Vis. Comput. Graph., vol. 19, no. 10, pp. 1700-1707, 2013, doi: 10.1109/TVCG.2013.74), Araújo and Oliveira et al. (A. M. C. Araújo and M. M. Oliveira, “Connectivity-based cylinder detection in unorganized point clouds,” Pattern Recognit., vol. 100, p. 107161, April 2020, doi: 10.1016/j.patcog.2019.107161), Jin and Lee (Y.-H. Jin and W.-H. Lee, “Fast Cylinder Shape Matching Using Random Sample Consensus in Large Scale Point Cloud,” Appl. Sci., vol. 9, no. 5, p. 974, March 2019, doi: 10.3390/app 9050,974), Cheng et al (L. Cheng et al., “DeepPipes: Learning 3D pipelines reconstruction from point clouds,” Graph. Models, vol. 111, no. March, p. 101079, 2020, doi: 10.1016/j.gmod.2020.101079) and Wang et al. (B. Wang, C. Yin, H. Luo, J. C. P. Cheng, and Q. Wang, “Fully automated generation of parametric BIM for MEP scenes based on terrestrial laser scanning data,” Autom. Constr., vol. 125, no. February, p. 103615, 2021, doi: 10.1016/j.autcon.2021.103615). Compared with the above-mentioned Lee et al., which had the best recall rate reported, the processing time of the present method is much shorter on a per-point basis, and hence significantly more efficient.

$$recall = \frac{True Positive ( TP )}{Posi t i v e} \qquad ( 14 )$$

$$precision = \frac{TP}{Predicted Positive ( PP )} \qquad ( 13 )$$

$$F 1 = \frac{2 * recall * precision}{reca l l + p r e c i s i o n} \qquad ( 14 )$$

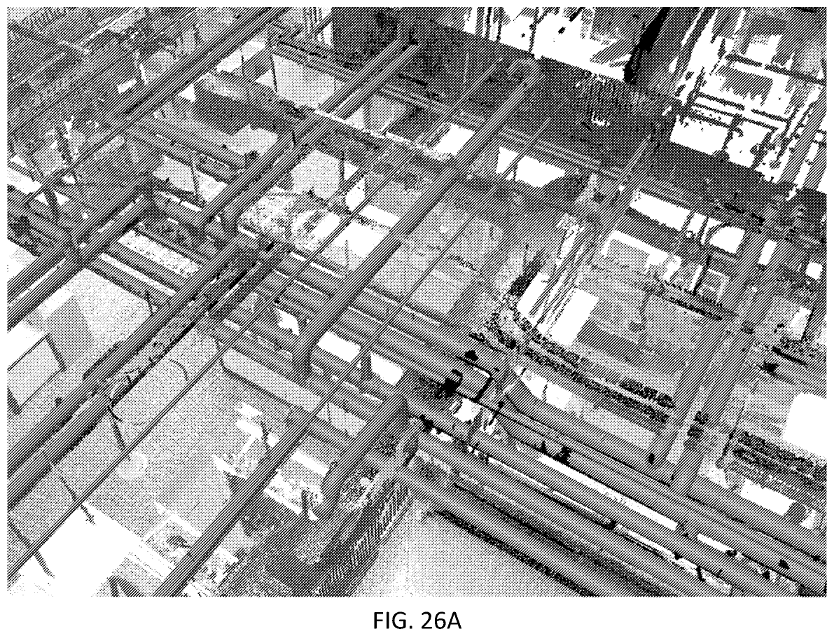

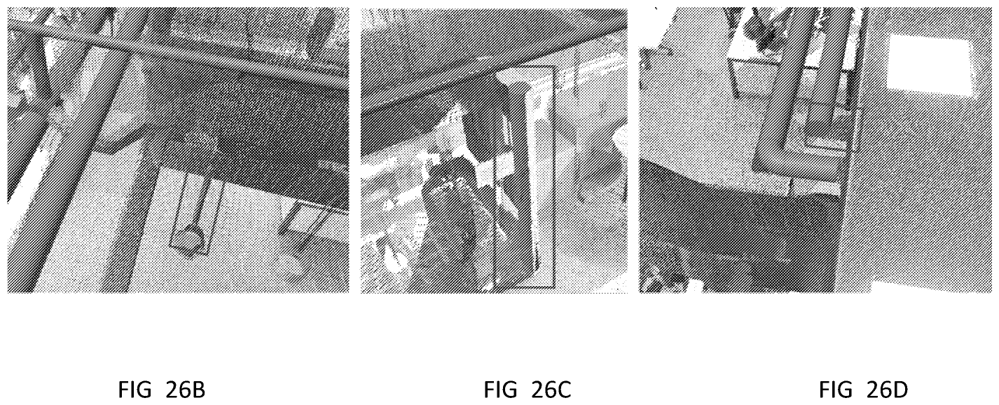

For the lab scene, selected close views of the reconstructed pipe model superimposed on the point cloud data are shown in FIGS. 26A to 26D, with the boxes highlighting the errors. In particular, FIG. 26A shows a close view of the IFC model superimposing on the point cloud data, FIG. 26B shows a false positive pipe is generated at a lighting cable, FIG. 26C shows a false positive pipe is generated at the curved portion of a phone booth, and FIG. 26D shows a missed pipe. There are mainly two types of sources of false positives. The first is as shown in FIG. 26B, where the electricity cables of lighting are misclassified by the PipeNet 402 as pipes. The second source is furniture with partial surfaces of circularly curved shapes such as the headrests and armrests of the sofas shown in FIG. 17C and legs of office chairs. This misclassification is because the PipeNet 402 has a limited field of view of the objects from the input patches with a limited radius. FIG. 26D shows a missed pipe segment of a length of 12 cm and with a scan of small angular coverage, which is turning into the false ceiling. This type of short pipe segment may be more prone to be missed out in the centerline candidate generation step due to its small number of centerline nodes. Nevertheless, it can be recovered if the structural model is available, by adding the structural components as additional nodes in the graph. The missed pipe segment and the ceiling can be considered as complement joint and their edge weight can be calculated in the same way as described hereinbefore in the Section “Connectivity reconstruction”.

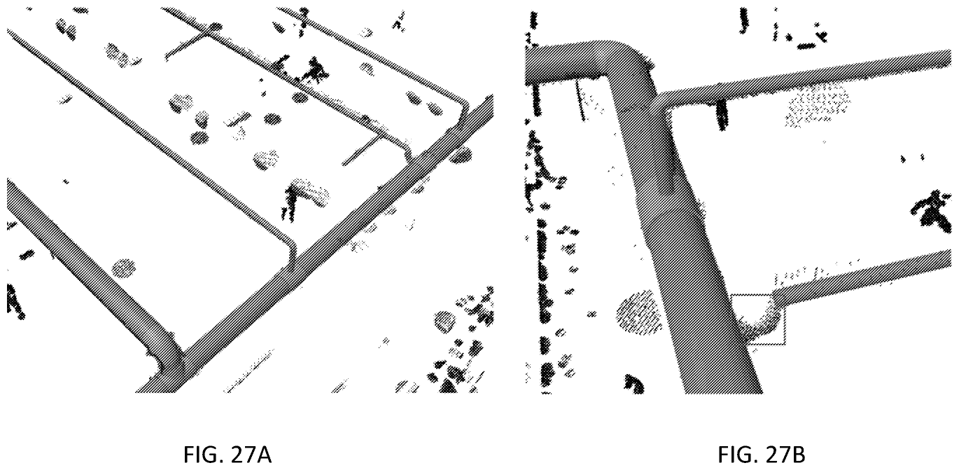

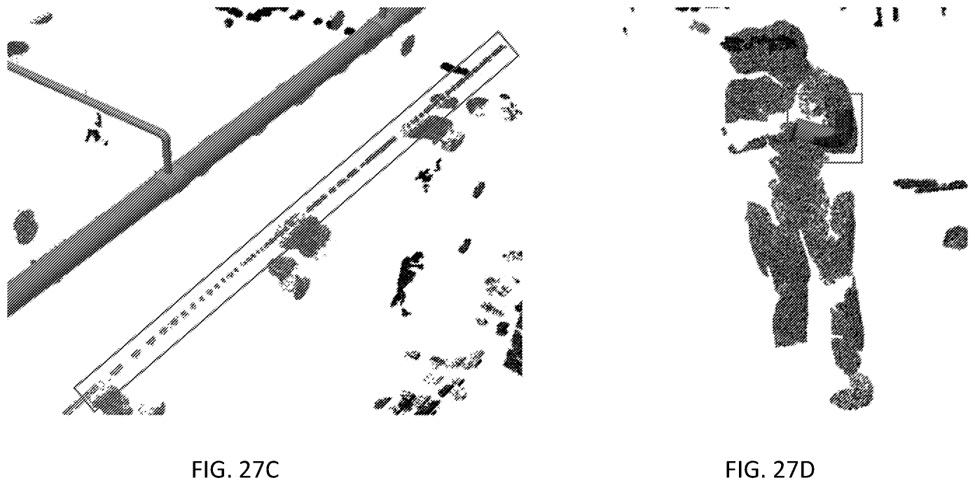

For the warehouse scene, FIGS. 27A to 27D show selected close views of the IFC model superimposed on the pipe points, with the boxes highlighting the errors. In particular, FIG. 27A shows a close view of the IFC model superimposed on the potential pipe points, FIGS. 27B and 27C show examples of missed pipe segments, and FIG. 27D shows examples of false positives generated on the limbs of a person. The missed pipes in FIG. 27B are due to their short lengths of about 8 cm. Although the warehouse is an empty space without any furniture, it is more challenging for both the scanning and the reconstruction because most of the pipes are small in size and are installed near the ceiling at a height of about 10 m. Sparse scans, scans with small angular coverage, and missing scans are observed frequently especially at pipes near the walls, as shown in FIG. 27C, because of the limited range of laser incidence angle from the scanner placed at the ground to those pipes. The false positives are generated typically at objects with surfaces of circular or nearly circular cross-sectional shapes, for example, the staircase handrails and the limbs of people captured in the scan, as shown in FIG. 27D. These types of false positives may be filtered if the structural model is available, by analyzing the relative locations between the generated pipes and the structural components.

Accordingly, various example embodiments of the present invention advantageously provide a method for automatically reconstructing as-built BIM models for piping systems from the point cloud. For example, the method requires no additional data other than the point cloud with XYZ fields, no preprocessing to the input data such as normal estimation, or prior knowledge of the pipes such as their directions. In various example embodiments, the method comprises two stages: in a first stage (corresponding to the PipeNet 402), a deep learning network is developed to extract the pipe points from the input data and predict the pipe centerline points as well as other pipe parameters including the radius and the unoriented flow direction for each sampled point. In particular, the DSM module 512 may be configured to select optimal true neighbor points that belong to the same pipe segment as the seed point and thus helps better predict the pipe parameters. In a second stage, the predicted centerline nodes are further processed to output the IFC model in a plurality of processes, including centerline candidate generation through region growing and RANSAC line fitting, centerline refinement through iterative line merging and circle fitting, and finally connectivity reconstruction based on graph theory constrained by domain knowledge.

As described hereinbefore in detail, the present method is validated on both synthetic data and actual scans. The DSM module 512 is validated by comparing with ablation models, the baseline model, and a SOTA model on synthetic data where pipes are arranged close to each other together with non-pipe objects. The results prove that the DSM 512 is effective in filtering outliers and that the PipeNet 402 can predict consistently accurate centerline nodes and pipe radii in all noise conditions. The sensitivity of the present method to the scan angular coverage and noise is also evaluated on synthetic data. Although the results show that scans with angular coverage ≥120° may be preferred to reconstruct small pipes with radii ≤2 cm, the present method presents robustness to both conditions in general. In the actual scan tests, one scene is a fully operational lab with complex piping systems as well as furniture and people around. The other scene is an empty warehouse with an 11 m-high ceiling and a fire protection piping system installed just below the ceiling. The present method works successfully for both scenes, achieving in total 0.94 recall, 0.89 precision, and 0.92 F1 score, which outperforms most existing works. The reconstruction takes 9.53 mins and 24.14 mins respectively, which is significantly more efficient than manual modeling.

In various example embodiments, because of the design of the patch input to the PipeNet 402, the neighborhood information available to the seed point may be limited. This limitation may cause the generation of false positives at non-pipe objects that have a partial circular or near-to-circular cross-sectional surface. To address this, various example embodiments may apply the point embedder on the entire or a larger size of point cloud data. This would then allow each point to be embedded with features of a larger neighborhood, thus providing richer information to the seed points. Furthermore, in various example embodiments, it may be assumed that the pipes are dominant with straight segments. Although this assumption holds true for most of the piping systems, it may fail at the trap components such as U- or S-trap which may be common in the sewage system. To address this, various example embodiments perform reconstruction of these kinds of irregular components by matching the BIM model with the point clouds at the potential areas. For example, short centerline candidates are usually generated at those components implying the existence of such components.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of building information modeling (BIM) reconstruction for a piping system using at least one processor, the method comprising:
obtaining a point cloud patch with respect to a seed point for the point cloud patch from point cloud data obtained with respect to the piping system, the point cloud patch comprising the seed point and a first plurality of neighbor points with respect to the seed point;
embedding, for each of the first plurality of neighbor points, neighborhood features with respect to the neighbor point to the neighbor point to form a neighborhood feature embedded point cloud patch;
generating a point cloud sub-patch comprising a second plurality of neighbor points from the first plurality of neighbor points of the neighborhood feature embedded point cloud patch, each of the second plurality of neighbor points being determined to belong to a same pipe segment as the seed point using a first machine learning model;
determining whether the seed point is a pipe point based on the point cloud sub-patch using a second machine learning model; and
determining a pipe centerline point associated with the seed point based on the point cloud sub-patch and based on determining that the seed point is a pipe point.

2. The method according to claim 1, wherein the neighborhood features with respect to the neighbor point are latent space features learned with respect to a local neighborhood of the neighbor point.

3. The method according to claim 1, wherein said determining the pipe centerline point associated with the seed point comprises:
determining a pipe radius associated with the seed point based on the point cloud sub-patch using a third machine learning model;
determining a point normal associated with the seed point based on the point cloud sub-patch using a fourth machine learning model; and
determining the pipe centerline point associated with the seed point based on the seed point, the pipe radius determined and the point normal determined.

4. The method according to claim 3, further comprising determining a pipe flow direction associated with the seed point based on the point cloud sub-patch using a fifth machine learning model.

5. The method according to claim 4, wherein
the first machine learning model is a first classification model trained to determine, for each of the first plurality of neighbor points, whether the neighbor point belongs to the same pipe segment as the seed point;
the second machine learning model is a second classification model trained to determine whether the seed point is a pipe point based on the point cloud sub-patch;
the third machine learning model is a first regression model trained to determine the pipe radius associated with the seed point based on the point cloud sub-patch;
the fourth machine learning model is a second regression model trained to determine the point normal associated with the seed point based on the point cloud sub-patch; and
the fifth machine learning model is a third regression model trained to determine the pipe flow direction associated with the seed point based on the point cloud sub-patch.

6. The method according to claim 1, wherein said obtaining the point cloud patch with respect to the seed point comprises extracting the plurality of neighbor points with respect to the seed point from the point cloud data using a ball query method or a k-nearest neighbors (k-NN) method.

7. The method according to claim 4, wherein
for each of a plurality of point cloud patches from the point cloud data, the method performs:
said obtaining the point cloud patch with respect to the seed point for the point cloud patch;
said embedding, for each of the first plurality of neighbor points, the neighborhood features with respect to the neighbor point to the neighbor point;
said generating the point cloud sub-patch;
said determining whether the seed point is a pipe point;
said determining the pipe centerline point associated with the seed point based on the point cloud sub-patch and based on said determining that the seed point is a pipe point; and
said determining the pipe flow direction associated with the seed point, and
the method further comprises generating a centerline parameter set comprising, for each of the plurality of point cloud patches comprising the seed point determined to be a pipe point, the pipe centerline point determined associated with the seed point for the point cloud patch, the pipe radius determined associated with the seed point for the point cloud patch and the pipe flow direction determined associated with the seed point for the point cloud patch, wherein the pipe radius determined and the pipe flow direction determined based on the point cloud patch are associated with the pipe centerline point determined based on the point cloud patch.

8. The method according to claim 7, further comprising:
generating a set of centerline candidates based on the centerline parameter set;
refining the set of centerline candidates to obtain a refined set of centerline candidates; and
generating a piping system model for the piping system based on the refined set of centerline candidates.

9. The method according to claim 8, wherein said generating the set of centerline candidates comprises:
dividing the centerline parameter set into a plurality of centerline parameter subsets based on, for each centerline point in the centerline parameter set, the centerline point and the pipe flow direction associated with the centerline point; and
applying, for each of the plurality of centerline parameter subsets, line fitting to the centerline parameter subset to generate a centerline candidate associated with the centerline parameter subset to obtain the set of centerline candidates.

10. The method according to claim 9, wherein each centerline candidate of the set of centerline candidates has associated therewith two endpoints, a direction vector, a radius and a set of inlier centerline points.

11. The method according to claim 10, wherein said refining the set of centerline candidates comprises, for each of a plurality of common centerline groups in turn:
setting a longest centerline candidate in the set of centerline candidates that does not yet belong to any of the plurality of common centerline groups as a seed centerline candidate associated with the common centerline group and adding the longest centerline candidate to the common centerline group;
adding, for each centerline candidate in the set of centerline candidates that does not yet belong to any of the plurality of common centerline groups, the centerline candidate to the common centerline group based on determining that the centerline candidate satisfies a common centerline condition between the centerline candidate and the seed centerline candidate, and setting the added centerline candidate as a new seed centerline candidate associated with the common centerline group; and
for each new seed centerline candidate that has been set in the common centerline group, in turn, adding, for each centerline candidate in the set of centerline candidates that does not yet belong to any of the plurality of common centerline groups, the centerline candidate to the common centerline group based on determining that the centerline candidate satisfies the common centerline condition between the centerline candidate and the seed centerline candidate, and setting the added centerline candidate as a new seed centerline candidate associated with the common centerline group.

12. The method according to claim 11, wherein the common centerline condition comprises a plurality of sub-conditions comprising a first sub-condition based on an angle formed by the direction vectors respectively associated with the centerline candidate and the seed centerline candidate, a second sub-condition based on a distance between the centerline candidate and the seed centerline candidate, and a third sub-condition based on a difference between the radiuses respectively associated with the centerline candidate and the seed centerline candidate.

13. The method according to claim 11, wherein said refining the set of centerline candidates further comprises applying, for each of the plurality of common centerline groups, line fitting to the common centerline group to form a refined centerline candidate associated with the common centerline group to obtain the refined set of centerline candidates.

14. The method according to claim 13, wherein said refining the set of centerline candidates further comprises determining, for each of the plurality of common centerline groups, a radius associated with the refined centerline candidate associated with the common centerline group by applying circle fitting based on an extracted segment of the point cloud data corresponding to a length of the refined centerline candidate.

15. The method according to claim 8, wherein said generating the piping system model comprises performing graph-based centerline connectivity reconstruction based on the set of refined centerline candidates, comprising:
constructing a graph comprising a plurality of nodes for representing the set of refined centerline candidates, wherein each node represents a corresponding refined centerline candidate of the set of refined centerline candidates and each pair of nodes of the plurality of nodes has an edge weight assigned thereto;
generating a minimum spanning forest comprising a plurality of minimum spanning trees based on the graph; and
performing centerline connections on the set of refined centerline candidates based on the minimum spanning forest.

16. The method according to claim 15, wherein said performing graph-based centerline connectivity reconstruction further comprises:
determining, for each pair of nodes of the plurality of nodes, the edge weight assigned thereto based on the Euclidean distance between a pair of refined centerline candidates of the set of refined centerline candidates corresponding to the pair of nodes, scan data density at a potential connection region between the pair of refined centerline candidates, a direction angle difference between the pair of refined centerline candidates and a radius difference between the pair of refined centerline candidates.

17. A system for building information modeling (BIM) reconstruction for a piping system, the system comprising:
at least one memory; and
at least one processor communicatively coupled to the at least one memory and configured to perform the method of BIM reconstruction according to claim 1.

18. A computer program product, embodied in one or more non-transitory computer-readable storage mediums, comprising instructions executable by at least one processor to perform the method of BIM reconstruction according to claim 1.
